(19) United States
(12) Patent Application Publication
(10) Pub. No.: US 2024/0118389 A1
(43) Pub. Date: Apr. 11, 2024

(54) CURVED WINDOW FOR EXPANSION OF FOV IN LIDAR APPLICATION

(71) Applicant: Innovusion, Inc., Sunnyvale, CA (US)

(72) Inventors: Junwei Bao, Los Altos, CA (US); Yufeng Li, Milpitas, CA (US); Yimin Li, Cupertino, CA (US)

(73) Assignee: Innovusion, Inc., Sunnyvale, CA (US)

(21) Appl. No.: 18/376,815

(22) Filed: Oct. 4, 2023

Related U.S. Application Data
(60) Provisional application No. 63/413,578, filed on Oct. 5, 2022.

(51) Int. Cl. G01S 7/481; G02B 26/10

(52) U.S. Cl. CPC G01S 7/4811; G02B 26/10

(57) ABSTRACT

A light ranging and detection (LiDAR) system is provided. The system comprises a housing; a transmitter configured to transmit one or more light beams; and a beam steering apparatus optically coupled to the transmitter to receive the one or more light beams. The beam steering apparatus comprises one or more moveable optics configured to scan the one or more light beams to a field-of-view and to receive return light. The system further comprises a curved window mounted to, or integrated with, the housing of the LiDAR system. The curved window is shaped in a manner such that a thickness of the curved window varies along one or more dimensions of the curved window to facilitate bending at least some of the scanned one or more light beams to expand the field-of-view (FOV) in at least one of a horizontal direction or a vertical direction.

### CROSS-REFERENCE TO RELATED APPLICATIONS

This application claims priority to U.S. Provisional Patent Application Ser. No. 63/413,578, filed Oct. 5, 2022, entitled “MENISCUS WINDOW FOR EXPANSION OF FOV IN LIDAR APPLICATION,” the content of which is hereby incorporated by reference in its entirety for all purposes.

### FIELD OF THE TECHNOLOGY

This disclosure relates generally to a light ranging and detection (LiDAR) system, and in particular, to a curved window for expanding a field-of-view (FOV) of the LiDAR system.

### BACKGROUND

Light detection and ranging (LiDAR) systems use light pulses to create an image or point cloud of the external environment. A LiDAR system may be a scanning or non-scanning system. Some typical scanning LiDAR systems include a light source, a light transmitter, a light steering system, and a light detector. The light source generates a light beam that is directed by the light steering system in particular directions when being transmitted from the LiDAR system. When a transmitted light beam is scattered or reflected by an object, a portion of the scattered or reflected light returns to the LiDAR system to form a return light pulse. The light detector detects the return light pulse. Using the difference between the time that the return light pulse is detected and the time that a corresponding light pulse in the light beam is transmitted, the LiDAR system can determine the distance to the object based on the speed of light. This technique of determining the distance is referred to as the time-of-flight (ToF) technique. The light steering system can direct light beams along different paths to allow the LiDAR system to scan the surrounding environment and produce images or point clouds. A typical non-scanning LiDAR system illuminate an entire field-of-view (FOV) rather than scanning through the FOV. An example of the non-scanning LiDAR system is a flash LiDAR, which can also use the ToF technique to measure the distance to an object. LiDAR systems can also use techniques other than time-of-flight and scanning to measure the surrounding environment.

### SUMMARY

Typical automotive LiDAR applications may require a horizontal field-of-view (HFOV) of 120° or more. A LiDAR system may include an optical scanner, which often uses a rotatable polygon mirror to scan the HFOV. When a rotatable polygon mirror is used as a part of the optical scanner, the horizontal FOV of the LiDAR system may be limited by the rotating angles corresponding to each facet of the polygon mirror. For example, as the number of facets of a polygon mirror increases, the scanning range of the rotating angles corresponding to each facet decreases, and therefore the horizontal FOV of the LiDAR system decreases too. Reducing the number of facets of a polygon mirror may not be desired because it reduces the scanning resolution and also increases the required rotational speed of the polygon mirror. When the polygon mirror must rotate at a high speed for an extended period of time, it impacts the reliability and lifetime of the polygon mirror. If a polygon mirror has four facets or five facets, for example, it is often challenging to reach 120° HFOV due to angular range and beam size limitations.

This disclosure provides a solution to the above-described problem using a curved window for the LiDAR system. A curved window may have a meniscus lens shape, an aspheric lens shape, barrel shape, or a free-form lens shape. The curved window can be configured to expand the HFOV of the LiDAR system (or any other sensing systems). For example, a properly-configured curved window can enable expanding the HFOV to more than 120°, which is not achievable by existing systems. The curved window can be a window having a meniscus shape in one dimension or both dimensions, depending on whether vertical FOV expansion is desirable or not. Using the curved window allows the expansion of FOV without having to change the polygon mirror itself or any other optical components of the optical scanner. Therefore, the technologies described herein improve the scanning range of the LiDAR system more efficiently, cause no or minimum impact to the optical scanner and other optical components of the LiDAR system, and in turn reduce the cost of making such an improvement.

A light detection and ranging (LiDAR) system is provided. The system comprises a housing; a transmitter configured to transmit one or more light beams; and a beam steering apparatus optically coupled to the transmitter to receive the one or more light beams. The beam steering apparatus comprises one or more moveable optics configured to scan the one or more light beams to a field-of-view and to receive return light. The system further comprises a curved window mounted to, or integrated with, the housing of the LiDAR system. The curved window is shaped in a manner such that a thickness of the curved window varies along one or more dimensions of the curved window to facilitate bending at least some of the scanned one or more light beams to expand the field-of-view (FOV) in at least one of a horizontal direction or a vertical direction.

### BRIEF DESCRIPTION OF THE DRAWINGS

The present application can be best understood by reference to the embodiments described below taken in conjunction with the accompanying drawing figures, in which like parts may be referred to by like numerals.

FIG. 1 illustrates one or more example LiDAR systems disposed or included in a motor vehicle.

FIG. 2 is a block diagram illustrating interactions between an example LiDAR system and multiple other systems including a vehicle perception and planning system.

FIG. 3 is a block diagram illustrating an example LiDAR system.

FIG. 4 is a block diagram illustrating an example fiber-based laser source.

FIGS. 5A-5C illustrate an example LiDAR system using pulse signals to measure distances to objects disposed in a field-of-view (FOV).

FIG. 6 is a block diagram illustrating an example apparatus used to implement systems, apparatus, and methods in various embodiments.

FIG. 7A is a block diagram illustrating a prior art aperture window that does not expand the FOV of a LiDAR system, according to some embodiments.

FIG. 7B is a diagram illustrating an example of FOV scanned by the LiDAR system having a regular aperture window, according to some embodiments.

FIG. 8 is a block diagram illustrating an example curved window for expanding the FOV of a LiDAR system, according to some embodiments.

FIG. 9 is a block diagram illustrating an example curved window for expanding the FOV of the LiDAR system, according to some embodiments.

FIG. 10A is a cross-sectional view of an example curved window for expanding the FOV of a LiDAR system, according to some embodiments.

FIG. 10B is perspective view of an example curved window for expanding the FOV of a LiDAR system, according to some embodiments.

FIG. 10C is a perspective view of another example curved window for expanding the FOV of a LiDAR system, according to some embodiments.

FIG. 10D is a cross-sectional view of an example curved window having an aspherical lens shape, according to some embodiments.

FIG. 10E is a cross-sectional view of an example curved window having a freeform shape, according to some embodiments.

FIG. 11 is a block diagram of an example transmitting light path for a LiDAR system having pre-compensation optics used with a curved window for expanding the FOV of the LiDAR system, according to some embodiments.

FIG. 12A is a diagram illustrating an example receiving light path for a LiDAR system having a flat aperture window that does not expand the FOV of the LiDAR system, according to some embodiments.

FIG. 12B is a diagram illustrating an example optical receiving path for a LiDAR system having a curved aperture window for expanding the FOV of the LiDAR system, according to some embodiments.

FIG. 13 is a diagram illustrating an example transceiver of a LiDAR system having a curved aperture window for expanding the FOV of the LiDAR system, according to some embodiments.

### DETAILED DESCRIPTION

To provide a more thorough understanding of various embodiments of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

Throughout the specification and claims, the following terms take the meanings explicitly associated herein, unless the context clearly dictates otherwise:

The phrase “in one embodiment” as used herein does not necessarily refer to the same embodiment, though it may. Thus, as described below, various embodiments of the disclosure may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices. The components or devices can be optical, mechanical, and/or electrical devices.

Although the following description uses terms “first,” “second,” etc. to describe various elements, these elements should not be limited by the terms. These terms are only used to distinguish one element from another. For example, a first edge could be termed a second edge and, similarly, a second edge could be termed a first edge, without departing from the scope of the various described examples. The first edge and the second edge can both be edges and, in some cases, can be separate and different edges.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

As used in the description herein and throughout the claims that follow, when a system, engine, server, device, module, or other computing element is described as being configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

It should be noted that any language directed to a computer should be read to include any suitable combination of computing devices or network platforms, including servers, interfaces, systems, databases, agents, peers, engines, controllers, modules, or other types of computing devices operating individually or collectively. One should appreciate the computing devices comprise a processor configured to execute software instructions stored on a tangible, non-transitory computer readable storage medium (e.g., hard drive, FPGA, PLA, solid state drive, RAM, flash, ROM, or any other volatile or non-volatile storage devices). The software instructions configure or program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

LiDAR systems are often used in automotive applications for scanning the external environment of a vehicle, to which a LiDAR system is mounted. The scanning range of the LiDAR system is also referred to as the field-of-view (FOV) of the LiDAR system. An FOV can have two components, a horizontal FOV (HFOV) and a vertical FOV (VFOV). The horizontal FOV refers to the scanning range in the horizontal direction. A horizontal direction refers to the direction substantially parallel to the road surface, or a surface of the platform to which the LiDAR system is mounted. The vertical FOV refers to the scanning range in the vertical direction. The vertical direction refers to the direction substantially perpendicular to the road surface, or a surface of the platform to which the LiDAR system is mounted. The HFOV encompasses, in the horizontal direction, the area in front of the LiDAR system and certain areas to the left and to the right of the LiDAR system. And the VFOV encompasses, in the vertical direction, the area in front of the LiDAR system and certain areas to the left and to the right of the LiDAR system. The combination of the HFOV and the VFOV, for example, covers the area in front of the vehicle in the direction of the vehicle's movement, and to the left and right sides of the vehicle. Typically, the HFOV may be required to be greater compared to the VFOV. For example, the HFOV may be required to be approximately 120° such that the LiDAR can better detect objects surrounding the vehicle. The VFOV may only be required to be approximately 30-45° because sensing objects in the direction of the sky, for example, is normally not required.

As described above, typical automotive LiDAR applications may require a horizontal field-of-view (HFOV) of 120° or more. A LiDAR system may include an optical scanner, which often uses a rotatable polygon mirror to scan the HFOV. When a rotatable polygon mirror is used as a part of the optical scanner, the horizontal FOV is limited by the rotating angles corresponding to each facet of the polygon mirror. For example, as the number of facets of a polygon mirror increases, the scanning range of the rotating angles corresponding to each facet decreases, and therefore the horizontal FOV decreases too. Reducing the number of facets of a polygon mirror may not be desired because it also reduces the scanning resolution and increases the required rotational speed of the polygon mirror. A high rotational speed impacts the reliability and lifetime of the polygon mirror. If a polygon mirror has four facets or five facets, for example, it is often challenging to obtain a 120° HFOV due to angular range and beam size limitations.

This disclosure provides a solution to the above-described problem using a curved window for the LiDAR system. A curved window may have a meniscus lens shape, an aspheric lens shape, barrel shape, or a free-form lens shape. The curved window can be configured to expand the HFOV and/or the VFOV of the LiDAR system (or any other sensing systems). Using the curved window for the LiDAR system, it can expand the HFOV, for example, to be more than 120°, which previous systems cannot achieve. The curved window can be a window having a meniscus shape in one dimension or both dimensions, depending on whether vertical FOV expansion is desirable or not. Using the curved window disclosed herein allows the expansion of FOV without having to change the polygon mirror or any other optical components of the optical scanner. Therefore, the technologies described herein improve the FOV of a LiDAR system more efficiently, cause no or minimum impact to the optical scanner and other optical components of the LiDAR system, and in turn reduce the cost of making such an improvement.

In one embodiment of the present disclosure, a light detection and ranging (LiDAR) system is provided. The system comprises a housing; a transmitter configured to transmit one or more light beams; and a beam steering apparatus optically coupled to the transmitter to receive the one or more light beams. The beam steering apparatus comprises one or more moveable optics configured to scan the one or more light beams to a field-of-view and to receive return light. The system further comprises a curved window mounted to, or integrated with, the housing of the LiDAR system. The curved window is shaped in a manner such that a thickness of the curved window varies along one or more dimensions of the curved window to facilitate bending at least some of the scanned one or more light beams to expand the field-of-view (FOV) in at least one of a horizontal direction or a vertical direction.

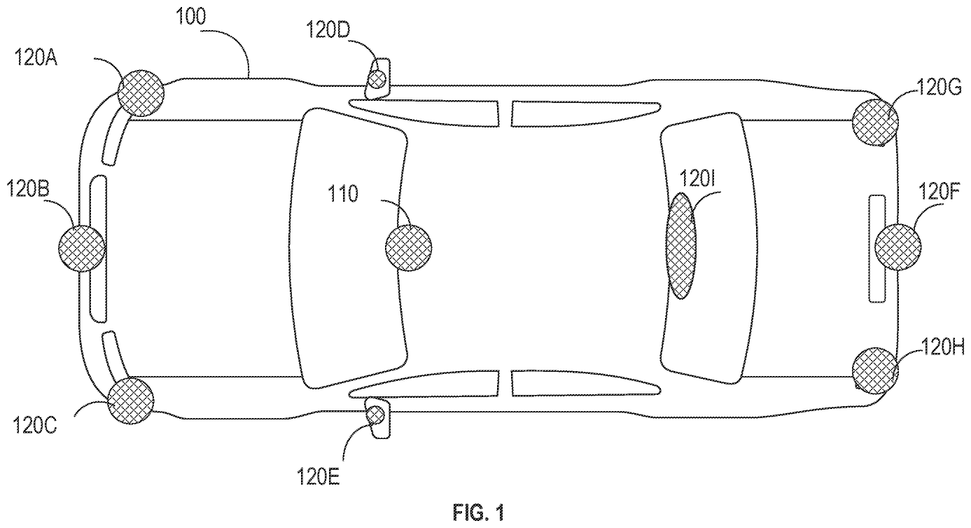

FIG. 1 illustrates one or more example LiDAR systems 110 and 120A-120I disposed or included in a motor vehicle 100. Vehicle 100 can be a car, a sport utility vehicle (SUV), a truck, a train, a wagon, a bicycle, a motorcycle, a tricycle, a bus, a mobility scooter, a tram, a ship, a boat, an underwater vehicle, an airplane, a helicopter, an unmanned aviation vehicle (UAV), a spacecraft, etc. Motor vehicle 100 can be a vehicle having any automated level. For example, motor vehicle 100 can be a partially automated vehicle, a highly automated vehicle, a fully automated vehicle, or a driverless vehicle. A partially automated vehicle can perform some driving functions without a human driver's intervention. For example, a partially automated vehicle can perform blind-spot monitoring, lane keeping and/or lane changing operations, automated emergency braking, smart cruising and/or traffic following, or the like. Certain operations of a partially automated vehicle may be limited to specific applications or driving scenarios (e.g., limited to only freeway driving). A highly automated vehicle can generally perform all operations of a partially automated vehicle but with less limitations. A highly automated vehicle can also detect its own limits in operating the vehicle and ask the driver to take over the control of the vehicle when necessary. A fully automated vehicle can perform all vehicle operations without a driver's intervention but can also detect its own limits and ask the driver to take over when necessary. A driverless vehicle can operate on its own without any driver intervention.

In typical configurations, motor vehicle 100 comprises one or more LiDAR systems 110 and 120A-120I. Each of LiDAR systems 110 and 120A-120I can be a scanning-based LiDAR system and/or a non-scanning LiDAR system (e.g., a flash LiDAR). A scanning-based LiDAR system scans one or more light beams in one or more directions (e.g., horizontal and vertical directions) to detect objects in a field-of-view (FOV). A non-scanning based LiDAR system transmits laser light to illuminate an FOV without scanning. For example, a flash LiDAR is a type of non-scanning based LiDAR system. A flash LiDAR can transmit laser light to simultaneously illuminate an FOV using a single light pulse or light shot.

A LiDAR system is a frequently-used sensor of a vehicle that is at least partially automated. In one embodiment, as shown in FIG. 1, motor vehicle 100 may include a single LiDAR system 110 (e.g., without LiDAR systems 120A-120I) disposed at the highest position of the vehicle (e.g., at the vehicle roof). Disposing LiDAR system 110 at the vehicle roof facilitates a 360-degree scanning around vehicle 100. In some other embodiments, motor vehicle 100 can include multiple LiDAR systems, including two or more of systems 110 and/or 120A-120I. As shown in FIG. 1, in one embodiment, multiple LiDAR systems 110 and/or 120A-120I are attached to vehicle 100 at different locations of the vehicle. For example, LiDAR system 120A is attached to vehicle 100 at the front right corner; LiDAR system 120B is attached to vehicle 100 at the front center position; LiDAR system 120C is attached to vehicle 100 at the front left corner; LiDAR system 120D is attached to vehicle 100 at the right-side rear view mirror; LiDAR system 120E is attached to vehicle 100 at the left-side rear view mirror; LiDAR system 120F is attached to vehicle 100 at the back center position; LiDAR system 120G is attached to vehicle 100 at the back right corner; LiDAR system 120H is attached to vehicle 100 at the back left corner; and/or LiDAR system 120I is attached to vehicle 100 at the center towards the backend (e.g., back end of the vehicle roof). It is understood that one or more LiDAR systems can be distributed and attached to a vehicle in any desired manner and FIG. 1 only illustrates one embodiment. As another example, LiDAR systems 120D and 120E may be attached to the B-pillars of vehicle 100 instead of the rear-view mirrors. As another example, LiDAR system 120B may be attached to the windshield of vehicle 100 instead of the front bumper.

In some embodiments, LiDAR systems 110 and 120A-120I are independent LiDAR systems having their own respective laser sources, control electronics, transmitters, receivers, and/or steering mechanisms. In other embodiments, some of LiDAR systems 110 and 120A-120I can share one or more components, thereby forming a distributed sensor system. In one example, optical fibers are used to deliver laser light from a centralized laser source to all LiDAR systems. For instance, system 110 (or another system that is centrally positioned or positioned anywhere inside the vehicle 100) includes a light source, a transmitter, and a light detector, but has no steering mechanisms. System 110 may distribute transmission light to each of systems 120A-120I. The transmission light may be distributed via optical fibers. Optical connectors can be used to couple the optical fibers to each of system 110 and 120A-120I. In some examples, one or more of systems 120A-120I include steering mechanisms but no light sources, transmitters, or light detectors. A steering mechanism may include one or more moveable mirrors such as one or more polygon mirrors, one or more single plane mirrors, one or more multi-plane mirrors, or the like. Embodiments of the light source, transmitter, steering mechanism, and light detector are described in more detail below. Via the steering mechanisms, one or more of systems 120A-120I scan light into one or more respective FOVs and receive corresponding return light. The return light is formed by scattering or reflecting the transmission light by one or more objects in the FOVs. Systems 120A-120I may also include collection lens and/or other optics to focus and/or direct the return light into optical fibers, which deliver the received return light to system 110. System 110 includes one or more light detectors for detecting the received return light. In some examples, system 110 is disposed inside a vehicle such that it is in a temperature-controlled environment, while one or more systems 120A-120I may be at least partially exposed to the external environment.

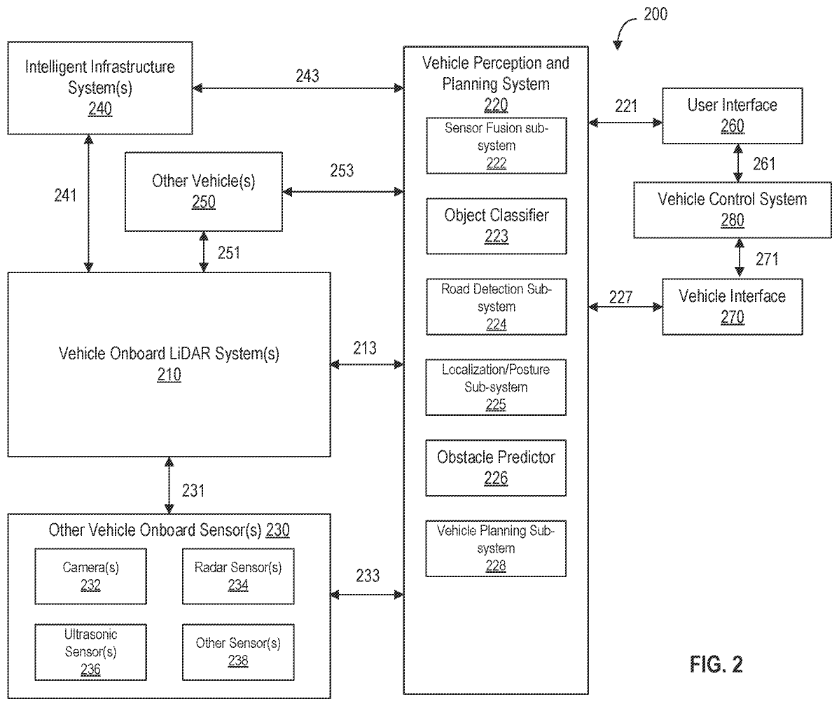

FIG. 2 is a block diagram 200 illustrating interactions between vehicle onboard LiDAR system(s) 210 and multiple other systems including a vehicle perception and planning system 220. LiDAR system(s) 210 can be mounted on or integrated to a vehicle. LiDAR system(s) 210 include sensor(s) that scan laser light to the surrounding environment to measure the distance, angle, and/or velocity of objects. Based on the scattered light that returned to LiDAR system(s) 210, it can generate sensor data (e.g., image data or 3D point cloud data) representing the perceived external environment.

LiDAR system(s) 210 can include one or more of short-range LiDAR sensors, medium-range LiDAR sensors, and long-range LiDAR sensors. A short-range LiDAR sensor measures objects located up to about 20-50 meters from the LiDAR sensor. Short-range LiDAR sensors can be used for, e.g., monitoring nearby moving objects (e.g., pedestrians crossing street in a school zone), parking assistance applications, or the like. A medium-range LiDAR sensor measures objects located up to about 70-200 meters from the LiDAR sensor. Medium-range LiDAR sensors can be used for, e.g., monitoring road intersections, assistance for merging onto or leaving a freeway, or the like. A long-range LiDAR sensor measures objects located up to about 200 meters and beyond. Long-range LiDAR sensors are typically used when a vehicle is travelling at a high speed (e.g., on a freeway), such that the vehicle's control systems may only have a few seconds (e.g., 6-8 seconds) to respond to any situations detected by the LiDAR sensor. As shown in FIG. 2, in one embodiment, the LiDAR sensor data can be provided to vehicle perception and planning system 220 via a communication path 213 for further processing and controlling the vehicle operations. Communication path 213 can be any wired or wireless communication links that can transfer data.

With reference still to FIG. 2, in some embodiments, other vehicle onboard sensor(s) 230 are configured to provide additional sensor data separately or together with LiDAR system(s) 210. Other vehicle onboard sensors 230 may include, for example, one or more camera(s) 232, one or more radar(s) 234, one or more ultrasonic sensor(s) 236, and/or other sensor(s) 238. Camera(s) 232 can take images and/or videos of the external environment of a vehicle. Camera(s) 232 can take, for example, high-definition (HD) videos having millions of pixels in each frame. A camera includes image sensors that facilitate producing monochrome or color images and videos. Color information may be important in interpreting data for some situations (e.g., interpreting images of traffic lights). Color information may not be available from other sensors such as LiDAR or radar sensors. Camera(s) 232 can include one or more of narrow-focus cameras, wider-focus cameras, side-facing cameras, infrared cameras, fisheye cameras, or the like. The image and/or video data generated by camera(s) 232 can also be provided to vehicle perception and planning system 220 via communication path 233 for further processing and controlling the vehicle operations. Communication path 233 can be any wired or wireless communication links that can transfer data. Camera(s) 232 can be mounted on, or integrated to, a vehicle at any location (e.g., rear-view mirrors, pillars, front grille, and/or back bumpers, etc.).

Other vehicle onboard sensor(s) 230 can also include radar sensor(s) 234. Radar sensor(s) 234 use radio waves to determine the range, angle, and velocity of objects. Radar sensor(s) 234 produce electromagnetic waves in the radio or microwave spectrum. The electromagnetic waves reflect off an object and some of the reflected waves return to the radar sensor, thereby providing information about the object's position and velocity. Radar sensor(s) 234 can include one or more of short-range radar(s), medium-range radar(s), and long-range radar(s). A short-range radar measures objects located at about 0.1-30 meters from the radar. A short-range radar is useful in detecting objects located near the vehicle, such as other vehicles, buildings, walls, pedestrians, bicyclists, etc. A short-range radar can be used to detect a blind spot, assist in lane changing, provide rear-end collision warning, assist in parking, provide emergency braking, or the like. A medium-range radar measures objects located at about 30-80 meters from the radar. A long-range radar measures objects located at about 80-200 meters. Medium- and/or long-range radars can be useful in, for example, traffic following, adaptive cruise control, and/or highway automatic braking. Sensor data generated by radar sensor(s) 234 can also be provided to vehicle perception and planning system 220 via communication path 233 for further processing and controlling the vehicle operations. Radar sensor(s) 234 can be mounted on, or integrated to, a vehicle at any location (e.g., rear-view mirrors, pillars, front grille, and/or back bumpers, etc.).

Other vehicle onboard sensor(s) 230 can also include ultrasonic sensor(s) 236. Ultrasonic sensor(s) 236 use acoustic waves or pulses to measure objects located external to a vehicle. The acoustic waves generated by ultrasonic sensor(s) 236 are transmitted to the surrounding environment. At least some of the transmitted waves are reflected off an object and return to the ultrasonic sensor(s) 236. Based on the return signals, a distance of the object can be calculated. Ultrasonic sensor(s) 236 can be useful in, for example, checking blind spots, identifying parking spaces, providing lane changing assistance into traffic, or the like. Sensor data generated by ultrasonic sensor(s) 236 can also be provided to vehicle perception and planning system 220 via communication path 233 for further processing and controlling the vehicle operations. Ultrasonic sensor(s) 236 can be mount on, or integrated to, a vehicle at any location (e.g., rear-view mirrors, pillars, front grille, and/or back bumpers, etc.).

In some embodiments, one or more other sensor(s) 238 may be attached in a vehicle and may also generate sensor data. Other sensor(s) 238 may include, for example, global positioning systems (GPS), inertial measurement units (IMU), or the like. Sensor data generated by other sensor(s) 238 can also be provided to vehicle perception and planning system 220 via communication path 233 for further processing and controlling the vehicle operations. It is understood that communication path 233 may include one or more communication links to transfer data between the various sensor(s) 230 and vehicle perception and planning system 220.

In some embodiments, as shown in FIG. 2, sensor data from other vehicle onboard sensor(s) 230 can be provided to vehicle onboard LiDAR system(s) 210 via communication path 231. LiDAR system(s) 210 may process the sensor data from other vehicle onboard sensor(s) 230. For example, sensor data from camera(s) 232, radar sensor(s) 234, ultrasonic sensor(s) 236, and/or other sensor(s) 238 may be correlated or fused with sensor data LiDAR system(s) 210, thereby at least partially offloading the sensor fusion process performed by vehicle perception and planning system 220. It is understood that other configurations may also be implemented for transmitting and processing sensor data from the various sensors (e.g., data can be transmitted to a cloud or edge computing service provider for processing and then the processing results can be transmitted back to the vehicle perception and planning system 220 and/or LiDAR system 210).

With reference still to FIG. 2, in some embodiments, sensors onboard other vehicle(s) 250 are used to provide additional sensor data separately or together with LiDAR system(s) 210. For example, two or more nearby vehicles may have their own respective LiDAR sensor(s), camera(s), radar sensor(s), ultrasonic sensor(s), etc. Nearby vehicles can communicate and share sensor data with one another. Communications between vehicles are also referred to as V2V (vehicle to vehicle) communications. For example, as shown in FIG. 2, sensor data generated by other vehicle(s) 250 can be communicated to vehicle perception and planning system 220 and/or vehicle onboard LiDAR system(s) 210, via communication path 253 and/or communication path 251, respectively. Communication paths 253 and 251 can be any wired or wireless communication links that can transfer data.

Sharing sensor data facilitates a better perception of the environment external to the vehicles. For instance, a first vehicle may not sense a pedestrian that is behind a second vehicle but is approaching the first vehicle. The second vehicle may share the sensor data related to this pedestrian with the first vehicle such that the first vehicle can have additional reaction time to avoid collision with the pedestrian. In some embodiments, similar to data generated by sensor(s) 230, data generated by sensors onboard other vehicle(s) 250 may be correlated or fused with sensor data generated by LiDAR system(s) 210 (or with other LiDAR systems located in other vehicles), thereby at least partially offloading the sensor fusion process performed by vehicle perception and planning system 220.

In some embodiments, intelligent infrastructure system(s) 240 are used to provide sensor data separately or together with LiDAR system(s) 210. Certain infrastructures may be configured to communicate with a vehicle to convey information and vice versa. Communications between a vehicle and infrastructures are generally referred to as V2I (vehicle to infrastructure) communications. For example, intelligent infrastructure system(s) 240 may include an intelligent traffic light that can convey its status to an approaching vehicle in a message such as “changing to yellow in 5 seconds.” Intelligent infrastructure system(s) 240 may also include its own LiDAR system mounted near an intersection such that it can convey traffic monitoring information to a vehicle. For example, a left-turning vehicle at an intersection may not have sufficient sensing capabilities because some of its own sensors may be blocked by traffic in the opposite direction. In such a situation, sensors of intelligent infrastructure system(s) 240 can provide useful data to the left-turning vehicle. Such data may include, for example, traffic conditions, information of objects in the direction the vehicle is turning to, traffic light status and predictions, or the like. These sensor data generated by intelligent infrastructure system(s) 240 can be provided to vehicle perception and planning system 220 and/or vehicle onboard LiDAR system(s) 210, via communication paths 243 and/or 241, respectively. Communication paths 243 and/or 241 can include any wired or wireless communication links that can transfer data. For example, sensor data from intelligent infrastructure system(s) 240 may be transmitted to LiDAR system(s) 210 and correlated or fused with sensor data generated by LiDAR system(s) 210, thereby at least partially offloading the sensor fusion process performed by vehicle perception and planning system 220. V2V and V2I communications described above are examples of vehicle-to-X (V2X) communications, where the “X” represents any other devices, systems, sensors, infrastructure, or the like that can share data with a vehicle.

With reference still to FIG. 2, via various communication paths, vehicle perception and planning system 220 receives sensor data from one or more of LiDAR system(s) 210, other vehicle onboard sensor(s) 230, other vehicle(s) 250, and/or intelligent infrastructure system(s) 240. In some embodiments, different types of sensor data are correlated and/or integrated by a sensor fusion sub-system 222. For example, sensor fusion sub-system 222 can generate a 360-degree model using multiple images or videos captured by multiple cameras disposed at different positions of the vehicle. Sensor fusion sub-system 222 obtains sensor data from different types of sensors and uses the combined data to perceive the environment more accurately. For example, a vehicle onboard camera 232 may not capture a clear image because it is facing the sun or a light source (e.g., another vehicle's headlight during nighttime) directly. A LiDAR system 210 may not be affected as much and therefore sensor fusion sub-system 222 can combine sensor data provided by both camera 232 and LiDAR system 210, and use the sensor data provided by LiDAR system 210 to compensate the unclear image captured by camera 232. As another example, in a rainy or foggy weather, a radar sensor 234 may work better than a camera 232 or a LiDAR system 210. Accordingly, sensor fusion sub-system 222 may use sensor data provided by the radar sensor 234 to compensate the sensor data provided by camera 232 or LiDAR system 210.

In other examples, sensor data generated by other vehicle onboard sensor(s) 230 may have a lower resolution (e.g., radar sensor data) and thus may need to be correlated and confirmed by LiDAR system(s) 210, which usually has a higher resolution. For example, a sewage cover (also referred to as a manhole cover) may be detected by radar sensor 234 as an object towards which a vehicle is approaching. Due to the low-resolution nature of radar sensor 234, vehicle perception and planning system 220 may not be able to determine whether the object is an obstacle that the vehicle needs to avoid. High-resolution sensor data generated by LiDAR system(s) 210 thus can be used to correlated and confirm that the object is a sewage cover and causes no harm to the vehicle.

Vehicle perception and planning system 220 further comprises an object classifier 223. Using raw sensor data and/or correlated/fused data provided by sensor fusion sub-system 222, object classifier 223 can use any computer vision techniques to detect and classify the objects and estimate the positions of the objects. In some embodiments, object classifier 223 can use machine-learning based techniques to detect and classify objects. Examples of the machine-learning based techniques include utilizing algorithms such as region-based convolutional neural networks (R-CNN), Fast R-CNN, Faster R-CNN, histogram of oriented gradients (HOG), region-based fully convolutional network (R-FCN), single shot detector (SSD), spatial pyramid pooling (SPP-net), and/or You Only Look Once (Yolo).

Vehicle perception and planning system 220 further comprises a road detection sub-system 224. Road detection sub-system 224 localizes the road and identifies objects and/or markings on the road. For example, based on raw or fused sensor data provided by radar sensor(s) 234, camera(s) 232, and/or LiDAR system(s) 210, road detection sub-system 224 can build a 3D model of the road based on machine-learning techniques (e.g., pattern recognition algorithms for identifying lanes). Using the 3D model of the road, road detection sub-system 224 can identify objects (e.g., obstacles or debris on the road) and/or markings on the road (e.g., lane lines, turning marks, crosswalk marks, or the like).

Vehicle perception and planning system 220 further comprises a localization and vehicle posture sub-system 225. Based on raw or fused sensor data, localization and vehicle posture sub-system 225 can determine position of the vehicle and the vehicle's posture. For example, using sensor data from LiDAR system(s) 210, camera(s) 232, and/or GPS data, localization and vehicle posture sub-system 225 can determine an accurate position of the vehicle on the road and the vehicle's six degrees of freedom (e.g., whether the vehicle is moving forward or backward, up or down, and left or right). In some embodiments, high-definition (HD) maps are used for vehicle localization. HD maps can provide highly detailed, three-dimensional, computerized maps that pinpoint a vehicle's location. For instance, using the HD maps, localization and vehicle posture sub-system 225 can determine precisely the vehicle's current position (e.g., which lane of the road the vehicle is currently in, how close it is to a curb or a sidewalk) and predict vehicle's future positions.

Vehicle perception and planning system 220 further comprises obstacle predictor 226. Objects identified by object classifier 223 can be stationary (e.g., a light pole, a road sign) or dynamic (e.g., a moving pedestrian, bicycle, another car). For moving objects, predicting their moving path or future positions can be important to avoid collision. Obstacle predictor 226 can predict an obstacle trajectory and/or warn the driver or the vehicle planning sub-system 228 about a potential collision. For example, if there is a high likelihood that the obstacle's trajectory intersects with the vehicle's current moving path, obstacle predictor 226 can generate such a warning. Obstacle predictor 226 can use a variety of techniques for making such a prediction. Such techniques include, for example, constant velocity or acceleration models, constant turn rate and velocity/acceleration models, Kalman Filter and Extended Kalman Filter based models, recurrent neural network (RNN) based models, long short-term memory (LSTM) neural network based models, encoder-decoder RNN models, or the like.

With reference still to FIG. 2, in some embodiments, vehicle perception and planning system 220 further comprises vehicle planning sub-system 228. Vehicle planning sub-system 228 can include one or more planners such as a route planner, a driving behaviors planner, and a motion planner. The route planner can plan the route of a vehicle based on the vehicle's current location data, target location data, traffic information, etc. The driving behavior planner adjusts the timing and planned movement based on how other objects might move, using the obstacle prediction results provided by obstacle predictor 226. The motion planner determines the specific operations the vehicle needs to follow. The planning results are then communicated to vehicle control system 280 via vehicle interface 270. The communication can be performed through communication paths 227 and 271, which include any wired or wireless communication links that can transfer data.

Vehicle control system 280 controls the vehicle's steering mechanism, throttle, brake, etc., to operate the vehicle according to the planned route and movement. In some examples, vehicle perception and planning system 220 may further comprise a user interface 260, which provides a user (e.g., a driver) access to vehicle control system 280 to, for example, override or take over control of the vehicle when necessary. User interface 260 may also be separate from vehicle perception and planning system 220. User interface 260 can communicate with vehicle perception and planning system 220, for example, to obtain and display raw or fused sensor data, identified objects, vehicle's location/posture, etc. These displayed data can help a user to better operate the vehicle. User interface 260 can communicate with vehicle perception and planning system 220 and/or vehicle control system 280 via communication paths 221 and 261 respectively, which include any wired or wireless communication links that can transfer data. It is understood that the various systems, sensors, communication links, and interfaces in FIG. 2 can be configured in any desired manner and not limited to the configuration shown in FIG. 2.

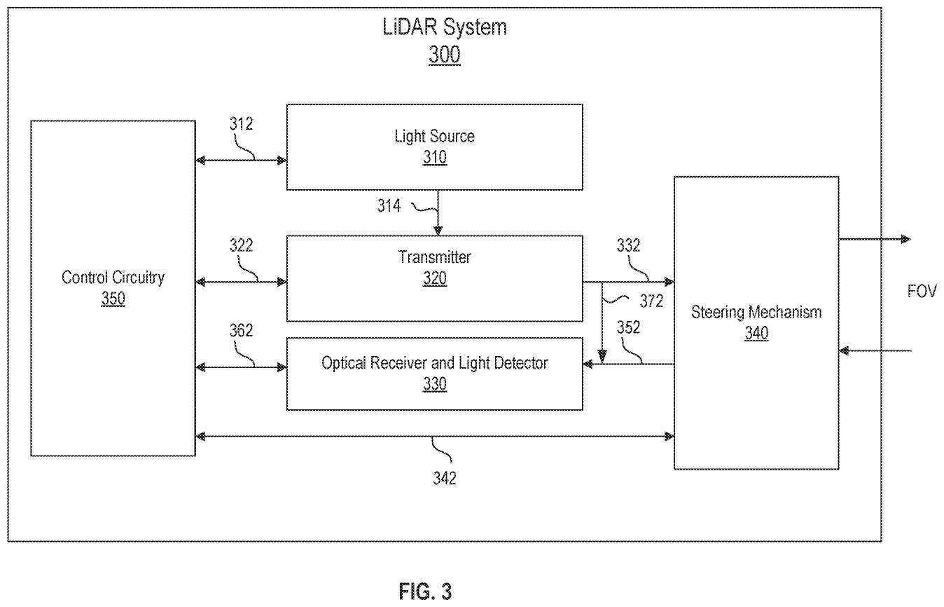

FIG. 3 is a block diagram illustrating an example LiDAR system 300. LiDAR system 300 can be used to implement LiDAR systems 110, 120A-120I, and/or 210 shown in FIGS. 1 and 2. In one embodiment, LiDAR system 300 comprises a light source 310, a transmitter 320, an optical receiver and light detector 330, a steering system 340, and a control circuitry 350. These components are coupled together using communications paths 312, 314, 322, 332, 342, 352, and 362. These communications paths include communication links (wired or wireless, bidirectional or unidirectional) among the various LiDAR system components, but need not be physical components themselves. While the communications paths can be implemented by one or more electrical wires, buses, or optical fibers, the communication paths can also be wireless channels or free-space optical paths so that no physical communication medium is present. For example, in one embodiment of LiDAR system 300, communication path 314 between light source 310 and transmitter 320 may be implemented using one or more optical fibers. Communication paths 332 and 352 may represent optical paths implemented using free space optical components and/or optical fibers. And communication paths 312, 322, 342, and 362 may be implemented using one or more electrical wires that carry electrical signals. The communications paths can also include one or more of the above types of communication mediums (e.g., they can include an optical fiber and a free-space optical component, or include one or more optical fibers and one or more electrical wires).

In some embodiments, LiDAR system 300 can be a coherent LiDAR system. One example is a frequency-modulated continuous-wave (FMCW) LiDAR. Coherent LiDARs detect objects by mixing return light from the objects with light from the coherent laser transmitter. Thus, as shown in FIG. 3, if LiDAR system 300 is a coherent LiDAR, it may include a route 372 providing a portion of transmission light from transmitter 320 to optical receiver and light detector 330. Route 372 may include one or more optics (e.g., optical fibers, lens, mirrors, etc.) for providing the light from transmitter 320 to optical receiver and light detector 330. The transmission light provided by transmitter 320 may be modulated light and can be split into two portions. One portion is transmitted to the FOV, while the second portion is sent to the optical receiver and light detector of the LiDAR system. The second portion is also referred to as the light that is kept local (LO) to the LiDAR system. The transmission light is scattered or reflected by various objects in the FOV and at least a portion of it forms return light. The return light is subsequently detected and interferometrically recombined with the second portion of the transmission light that was kept local. Coherent LiDAR provides a means of optically sensing an object's range as well as its relative velocity along the line-of-sight (LOS).

LiDAR system 300 can also include other components not depicted in FIG. 3, such as power buses, power supplies, LED indicators, switches, etc. Additionally, other communication connections among components may be present, such as a direct connection between light source 310 and optical receiver and light detector 330 to provide a reference signal so that the time from when a light pulse is transmitted until a return light pulse is detected can be accurately measured.

Light source 310 outputs laser light for illuminating objects in a field of view (FOV). The laser light can be infrared light having a wavelength in the range of 700 nm to 1 mm. Light source 310 can be, for example, a semiconductor-based laser (e.g., a diode laser) and/or a fiber-based laser. A semiconductor-based laser can be, for example, an edge emitting laser (EEL), a vertical cavity surface emitting laser (VCSEL), an external-cavity diode laser, a vertical-external-cavity surface-emitting laser, a distributed feedback (DFB) laser, a distributed Bragg reflector (DBR) laser, an interband cascade laser, a quantum cascade laser, a quantum well laser, a double heterostructure laser, or the like. A fiber-based laser is a laser in which the active gain medium is an optical fiber doped with rare-earth elements such as erbium, ytterbium, neodymium, dysprosium, praseodymium, thulium and/or holmium. In some embodiments, a fiber laser is based on double-clad fibers, in which the gain medium forms the core of the fiber surrounded by two layers of cladding. The double-clad fiber allows the core to be pumped with a high-power beam, thereby enabling the laser source to be a high power fiber laser source.

In some embodiments, light source 310 comprises a master oscillator (also referred to as a seed laser) and power amplifier (MOPA). The power amplifier amplifies the output power of the seed laser. The power amplifier can be a fiber amplifier, a bulk amplifier, or a semiconductor optical amplifier. The seed laser can be a diode laser (e.g., a Fabry-Perot cavity laser, a distributed feedback laser), a solid-state bulk laser, or a tunable external-cavity diode laser. In some embodiments, light source 310 can be an optically pumped microchip laser. Microchip lasers are alignment-free monolithic solid-state lasers where the laser crystal is directly contacted with the end mirrors of the laser resonator. A microchip laser is typically pumped with a laser diode (directly or using a fiber) to obtain the desired output power. A microchip laser can be based on neodymium-doped yttrium aluminum garnet (Y₃Al₅O₁₂) laser crystals (i.e., Nd:YAG), or neodymium-doped vanadate (i.e., ND:YVO₄) laser crystals. In some examples, light source 310 may have multiple amplification stages to achieve a high power gain such that the laser output can have high power, thereby enabling the LiDAR system to have a long scanning range. In some examples, the power amplifier of light source 310 can be controlled such that the power gain can be varied to achieve any desired laser output power.

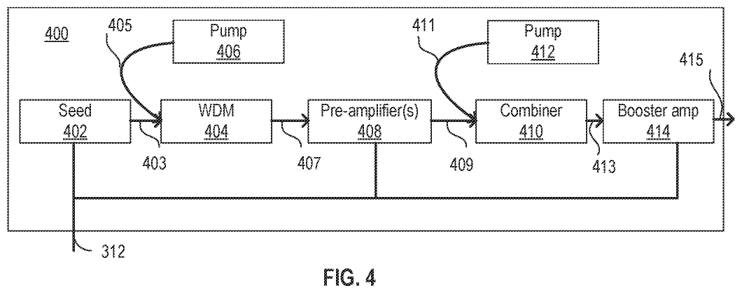

FIG. 4 is a block diagram illustrating an example fiber-based laser source 400 having a seed laser and one or more pumps (e.g., laser diodes) for pumping desired output power. Fiber-based laser source 400 is an example of light source 310 depicted in FIG. 3. In some embodiments, fiber-based laser source 400 comprises a seed laser 402 to generate initial light pulses of one or more wavelengths (e.g., infrared wavelengths such as 1550 nm), which are provided to a wavelength-division multiplexor (WDM) 404 via an optical fiber 403. Fiber-based laser source 400 further comprises a pump 406 for providing laser power (e.g., of a different wavelength, such as 980 nm) to WDM 404 via an optical fiber 405. WDM 404 multiplexes the light pulses provided by seed laser 402 and the laser power provided by pump 406 onto a single optical fiber 407. The output of WDM 404 can then be provided to one or more pre-amplifier(s) 408 via optical fiber 407. Pre-amplifier(s) 408 can be optical amplifier(s) that amplify optical signals (e.g., with about 10-30 dB gain). In some embodiments, pre-amplifier(s) 408 are low noise amplifiers. Pre-amplifier(s) 408 output to an optical combiner 410 via an optical fiber 409. Combiner 410 combines the output laser light of pre-amplifier(s) 408 with the laser power provided by pump 412 via an optical fiber 411. Combiner 410 can combine optical signals having the same wavelength or different wavelengths. One example of a combiner is a WDM. Combiner 410 provides combined optical signals to a booster amplifier 414, which produces output light pulses via optical fiber 415. The booster amplifier 414 provides further amplification of the optical signals (e.g., another 20-40 dB). The output light pulses can then be transmitted to transmitter 320 and/or steering mechanism 340 (shown in FIG. 3). It is understood that FIG. 4 illustrates one example configuration of fiber-based laser source 400. Laser source 400 can have many other configurations using different combinations of one or more components shown in FIG. 4 and/or other components not shown in FIG. 4 (e.g., other components such as power supplies, lens(es), filters, splitters, combiners, etc.).

In some variations, fiber-based laser source 400 can be controlled (e.g., by control circuitry 350) to produce pulses of different amplitudes based on the fiber gain profile of the fiber used in fiber-based laser source 400. Communication path 312 couples fiber-based laser source 400 to control circuitry 350 (shown in FIG. 3) so that components of fiber-based laser source 400 can be controlled by or otherwise communicate with control circuitry 350. Alternatively, fiber-based laser source 400 may include its own dedicated controller. Instead of control circuitry 350 communicating directly with components of fiber-based laser source 400, a dedicated controller of fiber-based laser source 400 communicates with control circuitry 350 and controls and/or communicates with the components of fiber-based laser source 400. Fiber-based laser source 400 can also include other components not shown, such as one or more power connectors, power supplies, and/or power lines.

Referencing FIG. 3, typical operating wavelengths of light source 310 comprise, for example, about 850 nm, about 905 nm, about 940 nm, about 1064 nm, and about 1550 nm. For laser safety, the upper limit of maximum usable laser power is set by the U.S. FDA (U.S. Food and Drug Administration) regulations. The optical power limit at 1550 nm wavelength is much higher than those of the other aforementioned wavelengths. Further, at 1550 nm, the optical power loss in a fiber is low. There characteristics of the 1550 nm wavelength make it more beneficial for long-range LiDAR applications. The amount of optical power output from light source 310 can be characterized by its peak power, average power, pulse energy, and/or the pulse energy density. The peak power is the ratio of pulse energy to the width of the pulse (e.g., full width at half maximum or FWHM). Thus, a smaller pulse width can provide a larger peak power for a fixed amount of pulse energy. A pulse width can be in the range of nanosecond or picosecond. The average power is the product of the energy of the pulse and the pulse repetition rate (PRR). As described in more detail below, the PRR represents the frequency of the pulsed laser light. In general, the smaller the time interval between the pulses, the higher the PRR. The PRR typically corresponds to the maximum range that a LiDAR system can measure. Light source 310 can be configured to produce pulses at high PRR to meet the desired number of data points in a point cloud generated by the LiDAR system. Light source 310 can also be configured to produce pulses at medium or low PRR to meet the desired maximum detection distance. Wall plug efficiency (WPE) is another factor to evaluate the total power consumption, which may be a useful indicator in evaluating the laser efficiency. For example, as shown in FIG. 1, multiple LiDAR systems may be attached to a vehicle, which may be an electrical-powered vehicle or a vehicle otherwise having limited fuel or battery power supply. Therefore, high WPE and intelligent ways to use laser power are often among the important considerations when selecting and configuring light source 310 and/or designing laser delivery systems for vehicle-mounted LiDAR applications.

It is understood that the above descriptions provide non-limiting examples of a light source 310. Light source 310 can be configured to include many other types of light sources (e.g., laser diodes, short-cavity fiber lasers, solid-state lasers, and/or tunable external cavity diode lasers) that are configured to generate one or more light signals at various wavelengths. In some examples, light source 310 comprises amplifiers (e.g., pre-amplifiers and/or booster amplifiers), which can be a doped optical fiber amplifier, a solid-state bulk amplifier, and/or a semiconductor optical amplifier. The amplifiers are configured to receive and amplify light signals with desired gains.

With reference back to FIG. 3, LiDAR system 300 further comprises a transmitter 320. Light source 310 provides laser light (e.g., in the form of a laser beam) to transmitter 320. The laser light provided by light source 310 can be amplified laser light with a predetermined or controlled wavelength, pulse repetition rate, and/or power level. Transmitter 320 receives the laser light from light source 310 and transmits the laser light to steering mechanism 340 with low divergence. In some embodiments, transmitter 320 can include, for example, optical components (e.g., lens, fibers, mirrors, etc.) for transmitting one or more laser beams to a field-of-view (FOV) directly or via steering mechanism 340. While FIG. 3 illustrates transmitter 320 and steering mechanism 340 as separate components, they may be combined or integrated as one system in some embodiments. Steering mechanism 340 is described in more detail below.

Laser beams provided by light source 310 may diverge as they travel to transmitter 320. Therefore, transmitter 320 often comprises a collimating lens configured to collect the diverging laser beams and produce more parallel optical beams with reduced or minimum divergence. The collimated optical beams can then be further directed through various optics such as mirrors and lens. A collimating lens may be, for example, a single plano-convex lens or a lens group. The collimating lens can be configured to achieve any desired properties such as the beam diameter, divergence, numerical aperture, focal length, or the like. A beam propagation ratio or beam quality factor (also referred to as the M² factor) is used for measurement of laser beam quality. In many LiDAR applications, it is important to have good laser beam quality in the generated transmitting laser beam. The M² factor represents a degree of variation of a beam from an ideal Gaussian beam. Thus, the M² factor reflects how well a collimated laser beam can be focused on a small spot, or how well a divergent laser beam can be collimated. Therefore, light source 310 and/or transmitter 320 can be configured to meet, for example, a scan resolution requirement while maintaining the desired M² factor.

One or more of the light beams provided by transmitter 320 are scanned by steering mechanism 340 to a FOV. Steering mechanism 340 scans light beams in multiple dimensions (e.g., in both the horizontal and vertical dimension) to facilitate LiDAR system 300 to map the environment by generating a 3D point cloud. A horizontal dimension can be a dimension that is parallel to the horizon, or a surface associated with the LiDAR system or a vehicle (e.g., a road surface). A vertical dimension is perpendicular to the horizontal dimension (i.e., the vertical dimension forms a 90-degree angle with the horizontal dimension). Steering mechanism 340 will be described in more detail below. The laser light scanned to an FOV may be scattered or reflected by an object in the FOV. At least a portion of the scattered or reflected light forms return light that returns to LiDAR system 300. FIG. 3 further illustrates an optical receiver and light detector 330 configured to receive the return light. Optical receiver and light detector 330 comprises an optical receiver that is configured to collect the return light from the FOV. The optical receiver can include optics (e.g., lens, fibers, mirrors, etc.) for receiving, redirecting, focusing, amplifying, and/or filtering return light from the FOV. For example, the optical receiver often includes a collection lens (e.g., a single plano-convex lens or a lens group) to collect and/or focus the collected return light onto a light detector.

A light detector detects the return light focused by the optical receiver and generates current and/or voltage signals proportional to the incident intensity of the return light. Based on such current and/or voltage signals, the depth information of the object in the FOV can be derived. One example method for deriving such depth information is based on the direct TOF (time of flight), which is described in more detail below. A light detector may be characterized by its detection sensitivity, quantum efficiency, detector bandwidth, linearity, signal to noise ratio (SNR), overload resistance, interference immunity, etc. Based on the applications, the light detector can be configured or customized to have any desired characteristics. For example, optical receiver and light detector 330 can be configured such that the light detector has a large dynamic range while having a good linearity. The light detector linearity indicates the detector's capability of maintaining linear relationship between input optical signal power and the detector's output. A detector having good linearity can maintain a linear relationship over a large dynamic input optical signal range.

To achieve desired detector characteristics, configurations or customizations can be made to the light detector's structure and/or the detector's material system. Various detector structures can be used for a light detector. For example, a light detector structure can be a PIN based structure, which has an undoped intrinsic semiconductor region (i.e., an “i” region) between a p-type semiconductor and an n-type semiconductor region. Other light detector structures comprise, for example, an APD (avalanche photodiode) based structure, a PMT (photomultiplier tube) based structure, a SiPM (Silicon photomultiplier) based structure, a SPAD (single-photon avalanche diode) based structure, and/or quantum wires. For material systems used in a light detector, Si, InGaAs, and/or Si/Ge based materials can be used. It is understood that many other detector structures and/or material systems can be used in optical receiver and light detector 330.

A light detector (e.g., an APD based detector) may have an internal gain such that the input signal is amplified when generating an output signal. However, noise may also be amplified due to the light detector's internal gain. Common types of noise include signal shot noise, dark current shot noise, thermal noise, and amplifier noise. In some embodiments, optical receiver and light detector 330 may include a pre-amplifier that is a low noise amplifier (LNA). In some embodiments, the pre-amplifier may also include a transimpedance amplifier (TIA), which converts a current signal to a voltage signal. For a linear detector system, input equivalent noise or noise equivalent power (NEP) measures how sensitive the light detector is to weak signals. Therefore, they can be used as indicators of the overall system performance. For example, the NEP of a light detector specifies the power of the weakest signal that can be detected and therefore it in turn specifies the maximum range of a LiDAR system. It is understood that various light detector optimization techniques can be used to meet the requirement of LiDAR system 300. Such optimization techniques may include selecting different detector structures, materials, and/or implementing signal processing techniques (e.g., filtering, noise reduction, amplification, or the like). For example, in addition to, or instead of, using direct detection of return signals (e.g., by using ToF), coherent detection can also be used for a light detector. Coherent detection allows for detecting amplitude and phase information of the received light by interfering the received light with a local oscillator. Coherent detection can improve detection sensitivity and noise immunity.

FIG. 3 further illustrates that LiDAR system 300 comprises steering mechanism 340. As described above, steering mechanism 340 directs light beams from transmitter 320 to scan an FOV in multiple dimensions. A steering mechanism is referred to as a raster mechanism, a scanning mechanism, or simply a light scanner. Scanning light beams in multiple directions (e.g., in both the horizontal and vertical directions) facilitates a LiDAR system to map the environment by generating an image or a 3D point cloud. A steering mechanism can be based on mechanical scanning and/or solid-state scanning. Mechanical scanning uses rotating mirrors to steer the laser beam or physically rotate the LiDAR transmitter and receiver (collectively referred to as transceiver) to scan the laser beam. Solid-state scanning directs the laser beam to various positions through the FOV without mechanically moving any macroscopic components such as the transceiver. Solid-state scanning mechanisms include, for example, optical phased arrays based steering and flash LiDAR based steering. In some embodiments, because solid-state scanning mechanisms do not physically move macroscopic components, the steering performed by a solid-state scanning mechanism may be referred to as effective steering. A LiDAR system using solid-state scanning may also be referred to as a non-mechanical scanning or simply non-scanning LiDAR system (a flash LiDAR system is an example non-scanning LiDAR system).

Steering mechanism 340 can be used with a transceiver (e.g., transmitter 320 and optical receiver and light detector 330) to scan the FOV for generating an image or a 3D point cloud. As an example, to implement steering mechanism 340, a two-dimensional mechanical scanner can be used with a single-point or several single-point transceivers. A single-point transceiver transmits a single light beam or a small number of light beams (e.g., 2-8 beams) to the steering mechanism. A two-dimensional mechanical steering mechanism comprises, for example, polygon mirror(s), oscillating mirror(s), rotating prism(s), rotating tilt mirror surface(s), single-plane or multi-plane mirror(s), or a combination thereof. In some embodiments, steering mechanism 340 may include non-mechanical steering mechanism(s) such as solid-state steering mechanism(s). For example, steering mechanism 340 can be based on tuning wavelength of the laser light combined with refraction effect, and/or based on reconfigurable grating/phase array. In some embodiments, steering mechanism 340 can use a single scanning device to achieve two-dimensional scanning or multiple scanning devices combined to realize two-dimensional scanning.

As another example, to implement steering mechanism 340, a one-dimensional mechanical scanner can be used with an array or a large number of single-point transceivers. Specifically, the transceiver array can be mounted on a rotating platform to achieve 360-degree horizontal field of view. Alternatively, a static transceiver array can be combined with the one-dimensional mechanical scanner. A one-dimensional mechanical scanner comprises polygon mirror(s), oscillating mirror(s), rotating prism(s), rotating tilt mirror surface(s), or a combination thereof, for obtaining a forward-looking horizontal field of view. Steering mechanisms using mechanical scanners can provide robustness and reliability in high volume production for automotive applications.

As another example, to implement steering mechanism 340, a two-dimensional transceiver can be used to generate a scan image or a 3D point cloud directly. In some embodiments, a stitching or micro shift method can be used to improve the resolution of the scan image or the field of view being scanned. For example, using a two-dimensional transceiver, signals generated at one direction (e.g., the horizontal direction) and signals generated at the other direction (e.g., the vertical direction) may be integrated, interleaved, and/or matched to generate a higher or full resolution image or 3D point cloud representing the scanned FOV.

Some implementations of steering mechanism 340 comprise one or more optical redirection elements (e.g., mirrors or lenses) that steer return light signals (e.g., by rotating, vibrating, or directing) along a receive path to direct the return light signals to optical receiver and light detector 330. The optical redirection elements that direct light signals along the transmitting and receiving paths may be the same components (e.g., shared), separate components (e.g., dedicated), and/or a combination of shared and separate components. This means that in some cases the transmitting and receiving paths are different although they may partially overlap (or in some cases, substantially overlap or completely overlap).

With reference still to FIG. 3, LiDAR system 300 further comprises control circuitry 350. Control circuitry 350 can be configured and/or programmed to control various parts of the LiDAR system 300 and/or to perform signal processing. In a typical system, control circuitry 350 can be configured and/or programmed to perform one or more control operations including, for example, controlling light source 310 to obtain the desired laser pulse timing, the pulse repetition rate, and power; controlling steering mechanism 340 (e.g., controlling the speed, direction, and/or other parameters) to scan the FOV and maintain pixel registration and/or alignment; controlling optical receiver and light detector 330 (e.g., controlling the sensitivity, noise reduction, filtering, and/or other parameters) such that it is an optimal state; and monitoring overall system health/status for functional safety (e.g., monitoring the laser output power and/or the steering mechanism operating status for safety).

Control circuitry 350 can also be configured and/or programmed to perform signal processing to the raw data generated by optical receiver and light detector 330 to derive distance and reflectance information, and perform data packaging and communication to vehicle perception and planning system 220 (shown in FIG. 2). For example, control circuitry 350 determines the time it takes from transmitting a light pulse until a corresponding return light pulse is received; determines when a return light pulse is not received for a transmitted light pulse; determines the direction (e.g., horizontal and/or vertical information) for a transmitted/return light pulse; determines the estimated range in a particular direction; derives the reflectivity of an object in the FOV, and/or determines any other type of data relevant to LiDAR system 300.

LiDAR system 300 can be disposed in a vehicle, which may operate in many different environments including hot or cold weather, rough road conditions that may cause intense vibration, high or low humidities, dusty areas, etc. Therefore, in some embodiments, optical and/or electronic components of LiDAR system 300 (e.g., optics in transmitter 320, optical receiver and light detector 330, and steering mechanism 340) are disposed and/or configured in such a manner to maintain long term mechanical and optical stability. For example, components in LiDAR system 300 may be secured and sealed such that they can operate under all conditions a vehicle may encounter. As an example, an anti-moisture coating and/or hermetic sealing may be applied to optical components of transmitter 320, optical receiver and light detector 330, and steering mechanism 340 (and other components that are susceptible to moisture). As another example, housing(s), enclosure(s), fairing(s), and/or window can be used in LiDAR system 300 for providing desired characteristics such as hardness, ingress protection (IP) rating, self-cleaning capability, resistance to chemical and resistance to impact, or the like. In addition, efficient and economical methodologies for assembling LiDAR system 300 may be used to meet the LiDAR operating requirements while keeping the cost low.

It is understood by a person of ordinary skill in the art that FIG. 3 and the above descriptions are for illustrative purposes only, and a LiDAR system can include other functional units, blocks, or segments, and can include variations or combinations of these above functional units, blocks, or segments. For example, LiDAR system 300 can also include other components not depicted in FIG. 3, such as power buses, power supplies, LED indicators, switches, etc. Additionally, other connections among components may be present, such as a direct connection between light source 310 and optical receiver and light detector 330 so that light detector 330 can accurately measure the time from when light source 310 transmits a light pulse until light detector 330 detects a return light pulse.

These components shown in FIG. 3 are coupled together using communications paths 312, 314, 322, 332, 342, 352, and 362. These communications paths represent communication (bidirectional or unidirectional) among the various LiDAR system components but need not be physical components themselves. While the communications paths can be implemented by one or more electrical wires, buses, or optical fibers, the communication paths can also be wireless channels or open-air optical paths so that no physical communication medium is present. For example, in one example LiDAR system, communication path 314 includes one or more optical fibers; communication path 352 represents an optical path; and communication paths 312, 322, 342, and 362 are all electrical wires that carry electrical signals. The communication paths can also include more than one of the above types of communication mediums (e.g., they can include an optical fiber and an optical path, or one or more optical fibers and one or more electrical wires).

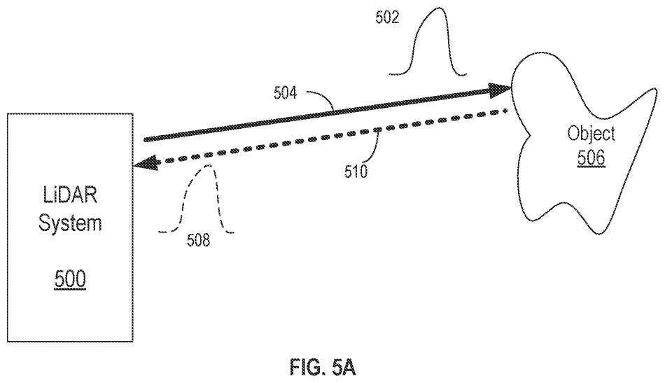

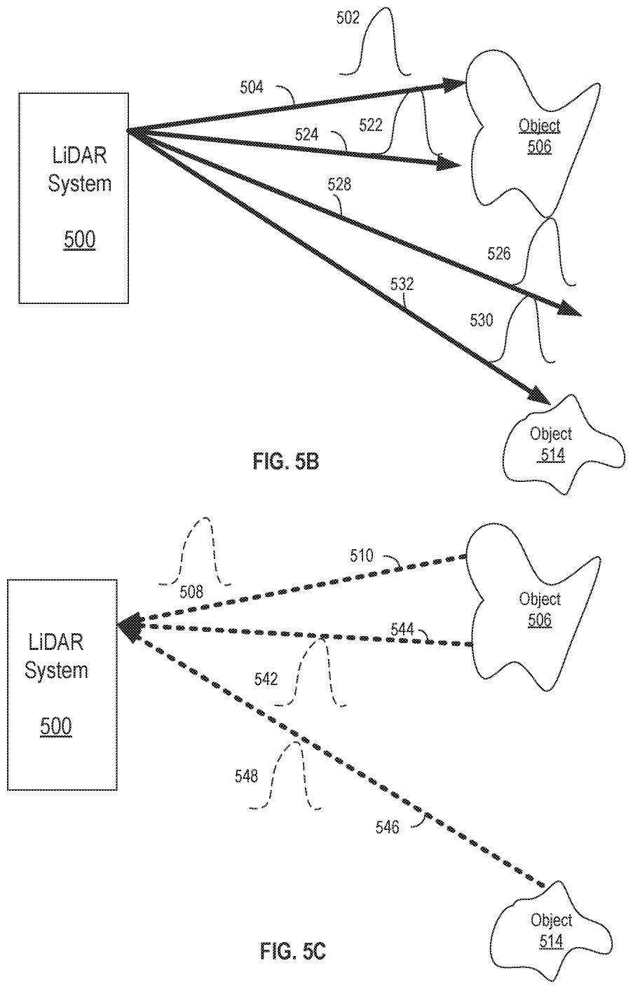

As described above, some LiDAR systems use the time-of-flight (ToF) of light signals (e.g., light pulses) to determine the distance to objects in a light path. For example, with reference to FIG. 5A, an example LiDAR system 500 includes a laser light source (e.g., a fiber laser), a steering mechanism (e.g., a system of one or more moving mirrors), and a light detector (e.g., a photodetector with one or more optics). LiDAR system 500 can be implemented using, for example, LiDAR system 300 described above. LiDAR system 500 transmits a light pulse 502 along light path 504 as determined by the steering mechanism of LiDAR system 500. In the depicted example, light pulse 502, which is generated by the laser light source, is a short pulse of laser light. Further, the signal steering mechanism of the LiDAR system 500 is a pulsed-signal steering mechanism. However, it should be appreciated that LiDAR systems can operate by generating, transmitting, and detecting light signals that are not pulsed and derive ranges to an object in the surrounding environment using techniques other than time-of-flight. For example, some LiDAR systems use frequency modulated continuous waves (i.e., “FMCW”). It should be further appreciated that any of the techniques described herein with respect to time-of-flight based systems that use pulsed signals also may be applicable to LiDAR systems that do not use one or both of these techniques.

Referring back to FIG. 5A (e.g., illustrating a time-of-flight LiDAR system that uses light pulses), when light pulse 502 reaches object 506, light pulse 502 scatters or reflects to form a return light pulse 508. Return light pulse 508 may return to system 500 along light path 510. The time from when transmitted light pulse 502 leaves LiDAR system 500 to when return light pulse 508 arrives back at LiDAR system 500 can be measured (e.g., by a processor or other electronics, such as control circuitry 350, within the LiDAR system). This time-of-flight combined with the knowledge of the speed of light can be used to determine the range/distance from LiDAR system 500 to the portion of object 506 where light pulse 502 scattered or reflected.

By directing many light pulses, as depicted in FIG. 5B, LiDAR system 500 scans the external environment (e.g., by directing light pulses 502, 522, 526, 530 along light paths 504, 524, 528, 532, respectively). As depicted in FIG. 5C, LiDAR system 500 receives return light pulses 508, 542, 548 (which correspond to transmitted light pulses 502, 522, 530, respectively). Return light pulses 508, 542, and 548 are formed by scattering or reflecting the transmitted light pulses by one of objects 506 and 514. Return light pulses 508, 542, and 548 may return to LiDAR system 500 along light paths 510, 544, and 546, respectively. Based on the direction of the transmitted light pulses (as determined by LiDAR system 500) as well as the calculated range from LiDAR system 500 to the portion of objects that scatter or reflect the light pulses (e.g., the portions of objects 506 and 514), the external environment within the detectable range (e.g., the field of view between path 504 and 532, inclusively) can be precisely mapped or plotted (e.g., by generating a 3D point cloud or images).

If a corresponding light pulse is not received for a particular transmitted light pulse, then LiDAR system 500 may determine that there are no objects within a detectable range of LiDAR system 500 (e.g., an object is beyond the maximum scanning distance of LiDAR system 500). For example, in FIG. 5B, light pulse 526 may not have a corresponding return light pulse (as illustrated in FIG. 5C) because light pulse 526 may not produce a scattering event along its transmission path 528 within the predetermined detection range. LiDAR system 500, or an external system in communication with LiDAR system 500 (e.g., a cloud system or service), can interpret the lack of return light pulse as no object being disposed along light path 528 within the detectable range of LiDAR system 500.

In FIG. 5B, light pulses 502, 522, 526, and 530 can be transmitted in any order, serially, in parallel, or based on other timings with respect to each other. Additionally, while FIG. 5B depicts transmitted light pulses as being directed in one dimension or one plane (e.g., the plane of the paper), LiDAR system 500 can also direct transmitted light pulses along other dimension(s) or plane(s). For example, LiDAR system 500 can also direct transmitted light pulses in a dimension or plane that is perpendicular to the dimension or plane shown in FIG. 5B, thereby forming a 2-dimensional transmission of the light pulses. This 2-dimensional transmission of the light pulses can be point-by-point, line-by-line, all at once, or in some other manner. That is, LiDAR system 500 can be configured to perform a point scan, a line scan, a one-shot without scanning, or a combination thereof. A point cloud or image from a 1-dimensional transmission of light pulses (e.g., a single horizontal line) can generate 2-dimensional data (e.g., (1) data from the horizontal transmission direction and (2) the range or distance to objects). Similarly, a point cloud or image from a 2-dimensional transmission of light pulses can generate 3-dimensional data (e.g., (1) data from the horizontal transmission direction, (2) data from the vertical transmission direction, and (3) the range or distance to objects). In general, a LiDAR system performing an n-dimensional transmission of light pulses generates (n+1) dimensional data. This is because the LiDAR system can measure the depth of an object or the range/distance to the object, which provides the extra dimension of data. Therefore, a 2D scanning by a LiDAR system can generate a 3D point cloud for mapping the external environment of the LiDAR system.

The density of a point cloud refers to the number of measurements (data points) per area performed by the LiDAR system. A point cloud density relates to the LiDAR scanning resolution. Typically, a larger point cloud density, and therefore a higher resolution, is desired at least for the region of interest (ROI). The density of points in a point cloud or image generated by a LiDAR system is equal to the number of pulses divided by the field of view. In some embodiments, the field of view can be fixed. Therefore, to increase the density of points generated by one set of transmission-receiving optics (or transceiver optics), the LiDAR system may need to generate a pulse more frequently. In other words, a light source in the LiDAR system may have a higher pulse repetition rate (PRR). On the other hand, by generating and transmitting pulses more frequently, the farthest distance that the LiDAR system can detect may be limited. For example, if a return signal from a distant object is received after the system transmits the next pulse, the return signals may be detected in a different order than the order in which the corresponding signals are transmitted, thereby causing ambiguity if the system cannot correctly correlate the return signals with the transmitted signals.

To illustrate, consider an example LiDAR system that can transmit laser pulses with a pulse repetition rate between 500 kHz and 1 MHz. Based on the time it takes for a pulse to return to the LiDAR system and to avoid mix-up of return pulses from consecutive pulses in a typical LiDAR design, the farthest distance the LiDAR system can detect may be 300 meters and 150 meters for 500 kHz and 1 MHz, respectively. The density of points of a LiDAR system with 500 kHz repetition rate is half of that with 1 MHz. Thus, this example demonstrates that, if the system cannot correctly correlate return signals that arrive out of order, increasing the repetition rate from 500 kHz to 1 MHz (and thus improving the density of points of the system) may reduce the detection range of the system. Various techniques are used to mitigate the tradeoff between higher PRR and limited detection range. For example, multiple wavelengths can be used for detecting objects in different ranges. Optical and/or signal processing techniques (e.g., pulse encoding techniques) are also used to correlate between transmitted and return light signals.

Various systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Various systems, apparatus, and methods described herein may be implemented using computers operating in a client-server relationship. Typically, in such a system, the client computers are located remotely from the server computers and interact via a network. The client-server relationship may be defined and controlled by computer programs running on the respective client and server computers. Examples of client computers can include desktop computers, workstations, portable computers, cellular smartphones, tablets, or other types of computing devices.

Various systems, apparatus, and methods described herein may be implemented using a computer program product tangibly embodied in an information carrier, e.g., in a non-transitory machine-readable storage device, for execution by a programmable processor; and the method processes and steps described herein, including one or more of the steps of at least some of the FIGS. 1-13, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

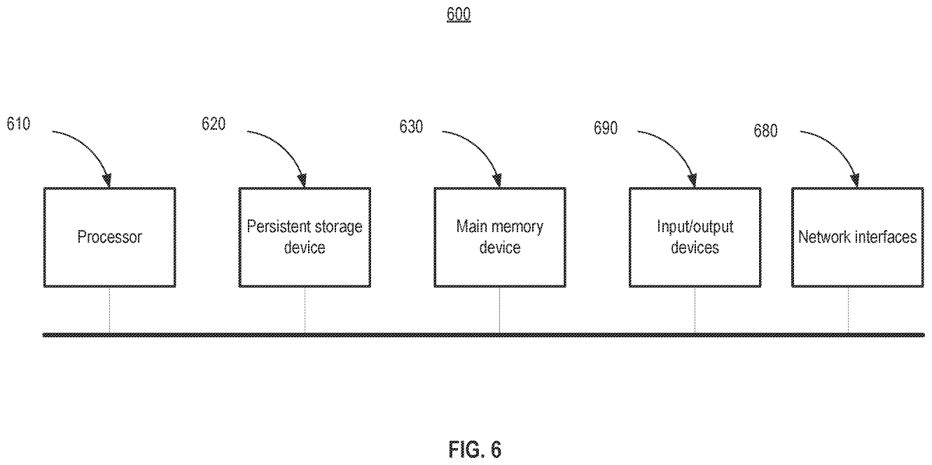

A high-level block diagram of an example apparatus that may be used to implement systems, apparatus and methods described herein is illustrated in FIG. 6. Apparatus 600 comprises a processor 610 operatively coupled to a persistent storage device 620 and a main memory device 630. Processor 610 controls the overall operation of apparatus 600 by executing computer program instructions that define such operations. The computer program instructions may be stored in persistent storage device 620, or other computer-readable medium, and loaded into main memory device 630 when execution of the computer program instructions is desired. For example, processor 610 may be used to implement one or more components and systems described herein, such as control circuitry 350 (shown in FIG. 3), vehicle perception and planning system 220 (shown in FIG. 2), and vehicle control system 280 (shown in FIG. 2). Thus, the method steps of at least some of FIGS. 1-13 can be defined by the computer program instructions stored in main memory device 630 and/or persistent storage device 620 and controlled by processor 610 executing the computer program instructions. For example, the computer program instructions can be implemented as computer executable code programmed by one skilled in the art to perform an algorithm defined by the method steps discussed herein in connection with at least some of FIGS. 1-13. Accordingly, by executing the computer program instructions, the processor 610 executes an algorithm defined by the method steps of these aforementioned figures. Apparatus 600 also includes one or more network interfaces 680 for communicating with other devices via a network. Apparatus 600 may also include one or more input/output devices 690 that enable user interaction with apparatus 600 (e.g., display, keyboard, mouse, speakers, buttons, etc.).

Processor 610 may include both general and special purpose microprocessors and may be the sole processor or one of multiple processors of apparatus 600. Processor 610 may comprise one or more central processing units (CPUs), and one or more graphics processing units (GPUs), which, for example, may work separately from and/or multi-task with one or more CPUs to accelerate processing, e.g., for various image processing applications described herein. Processor 610, persistent storage device 620, and/or main memory device 630 may include, be supplemented by, or incorporated in, one or more application-specific integrated circuits (ASICs) and/or one or more field programmable gate arrays (FPGAs).

Persistent storage device 620 and main memory device 630 each comprise a tangible non-transitory computer readable storage medium. Persistent storage device 620, and main memory device 630, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 690 may include peripherals, such as a printer, scanner, display screen, etc. For example, input/output devices 690 may include a display device such as a cathode ray tube (CRT), plasma or liquid crystal display (LCD) monitor for displaying information to a user, a keyboard, and a pointing device such as a mouse or a trackball by which the user can provide input to apparatus 600.

Any or all of the functions of the systems and apparatuses discussed herein may be performed by processor 610, and/or incorporated in, an apparatus or a system such as LiDAR system 300. Further, LiDAR system 300 and/or apparatus 600 may utilize one or more neural networks or other deep-learning techniques performed by processor 610 or other systems or apparatuses discussed herein.

One skilled in the art will recognize that an implementation of an actual computer or computer system may have other structures and may contain other components as well, and that FIG. 6 is a high-level representation of some of the components of such a computer for illustrative purposes.

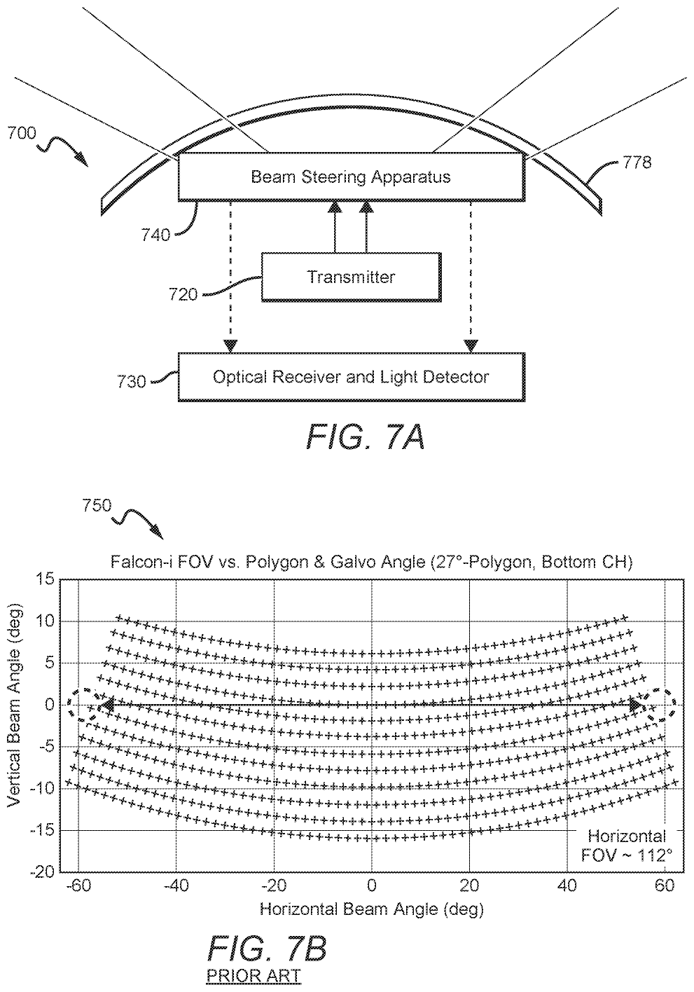

FIG. 7A is a block diagram illustrating a prior art aperture window 778 that does not expand the FOV of a LiDAR system 700, according to some embodiments. As shown in FIG. 7A, LiDAR system 700 comprises a transmitter 720, an optical receiver and light detector 730, a beam steering apparatus 740, and aperture window 778. Transmitter 720, optical receiver and light detector 730, and beam steering apparatus 740 can be substantially the same or similar to transmitter 320, optical receiver and light detector 330, and beam steering mechanism 340, respectively. In one example, transmitter 720 transmits one or more light beams to beam steering apparatus 740, which scans the one or more light beams to an FOV of the LiDAR system 700 via aperture window 778. Aperture window 778 is a regular window having no ability to expand the FOV of the LiDAR system 700. The window has a uniform thickness and thus does not bend, or only causes negligible bending of, the transmission light beams. The transmission light beams go through the aperture window 778 to scan the FOV.

FIG. 7B is a diagram illustrating an example of FOV 750 scanned by the LiDAR system 700 having a regular aperture window, according to some embodiments. As described above, the horizontal FOV scanned by a LiDAR system may be determined based on the number of facets used in a polygon mirror implementing the optical scanner. FIG. 7B shows that, by using the regular window that does not expand the FOV, the horizontal FOV for a LiDAR system in this example is about 112 degrees. The HFOV is thus below the desired range of 120 degrees or more. The VFOV for the example shown in FIG. 7B is only about 20-25 degrees, again without any FOV expansion provided by the regular window 778. The transmission light beams illuminate one or more objects in the FOV. Return light can be formed based on scattering or reflecting of the transmission light beams by the one or more objects in the FOV. However, because the HFOV does not meet the requirements (e.g., by a few degrees), any objects located outside of the HFOV of the LiDAR system 700 may not be detected. Lack of detection of the objects may cause the vehicle control system to improperly or incorrectly determine the vehicle's next movement, which in turn may cause accident. Similarly, if the VFOV also does not meet the scanning requirements, any object outside of the VFOV may also be missed and not detected (e.g., an object on the ground).

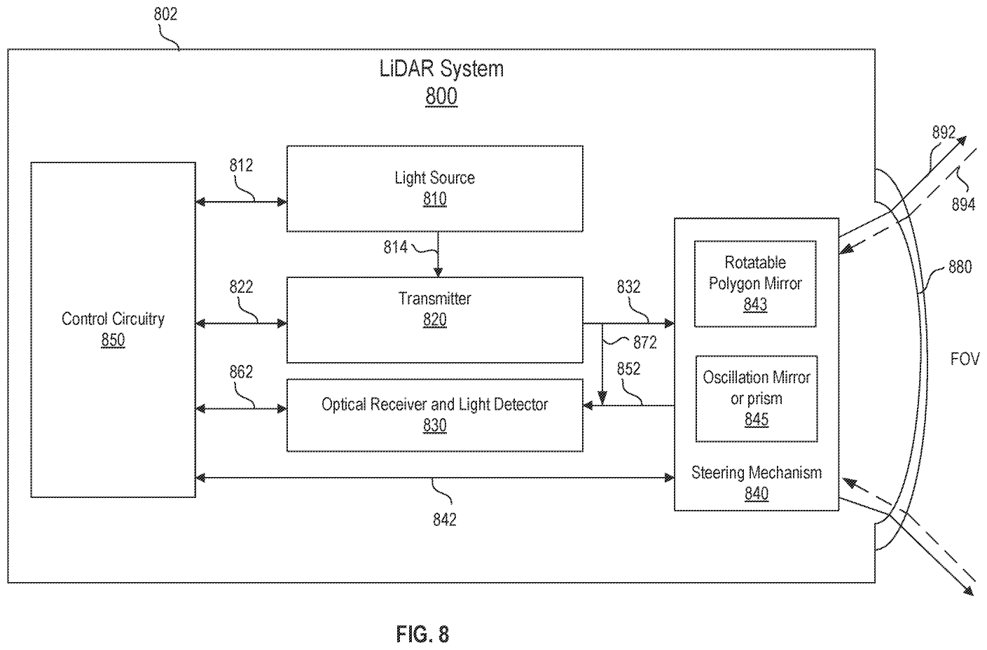

FIG. 8 is a block diagram illustrating an example curved window 880 for expanding the FOV of the LiDAR system 800, according to some embodiments. With reference to FIG. 8, in one example, LiDAR system 800 includes a light source 810, a transmitter 820, an optical receiver and light detector 830, a steering mechanism 840, and control circuitry 850. These components of LiDAR system 800 can be substantially the same or similar to light source 310, transmitter 320, optical receiver and light detector 330, steering mechanism 340, and control circuitry 350, respectively. Communications between these components of system 800 can be via the communication paths 812, 814, 822, 832, 842, 852, 862, and 872, which are also substantially the same or similar to those corresponding communication paths in system 300 described above.

In one embodiment, LiDAR system 800 also includes a housing 802 for enclosing at least some of the components, e.g., transmitter 820, optical receiver and light detector 830, and steering mechanism 840. The housing 802 comprises a plurality of panels forming the top, bottom, and side panels. These panels can be made of metals, plastics, rubbers, alloys, etc., The panels of housing 802 are not transparent and block light from travelling in and out of LiDAR system 800. The non-transparent panels of housing 800 thus facilitate blocking or reducing any noise, interference, and/or stray light from being received by optical receiver and light detector 830. In one embodiment, at least a portion of one side of housing 802 has a window so that scanning light beams can be transmitted to the FOV and return light can be received by the LiDAR system 800. One such window is shown in FIG. 8 as aperture window 880. Window 880 can be integrated to housing 802 such that they form an integral piece. Window 880 can also be detachably mounted to housing 802.

As shown in FIG. 8, transmitter 820 sends one or more light beams to steering mechanism 840, which includes one or more moveable optics configured to scan the light beams to an FOV to form transmission light beams 892. In some embodiments, one or more moveable optics are included in steering mechanism 840 for scanning the light beams. These moveable optics can include one or more of: a rotatable polygon mirror 843, an oscillation mirror or prism 845, and/or a combination thereof. Rotatable polygon mirror 843 may include a plurality of reflective facets to redirect light (e.g., both transmission light beams and return light). The number of reflective facets of the polygon mirror 843 is determined based on the scanning requirements and can be, for example, three, four, five, six, etc. Oscillation mirror or prism 845 includes one or both of a mirror and a prism. Rotatable polygon mirror 843 can be configured to rotate about an axis such that it scans the horizontal direction of the FOV; and the oscillation mirror or prism 845 can be configured to oscillate about another axis such that it scans the vertical direction of the FOV. In some embodiment, only a rotatable polygon mirror 843 may be used for scanning both horizontal and vertical directions of the FOV. Such a polygon mirror 843 can be a variable angle polygon mirror. Different facets of the variable angle polygon mirror may have different tilt angles such that different facets can be used to scan different angular ranges in a vertical FOV. In other embodiments, a combination of only an oscillation mirror and an oscillation prism is used for scanning both the HFOV and VFOV. In other embodiments, two oscillation mirror may be used for scanning both the HFOV and VFOV. It is understood that any combination of the moveable optics in steering mechanism can be used to scan the entire FOV, with or without other non-moveable optics (e.g., a folding mirror).

With reference to FIG. 8, steering mechanism 840 scans transmission light beams 892 to the FOV via aperture window 880. Aperture window 880 is a curved window that is shaped in a manner such that a thickness of the window 880 varies along one or more dimensions of the window 880 to facilitate bending at least some of the scanned one or more light beams to expand the field-of-view (FOV) in at least one of a horizontal direction or a vertical direction of LiDAR system 800. In FIG. 8, the thickness is greater near the edge of window 880 than at the center portion of window 880. As shown in FIG. 8, when passing through window 880, the transmission light beams 892 bend outward so that the scanning FOV is effectively enlarged. When return light 894 is formed and passes through window 880, the return light 894 also bends and is received by steering mechanism 840.

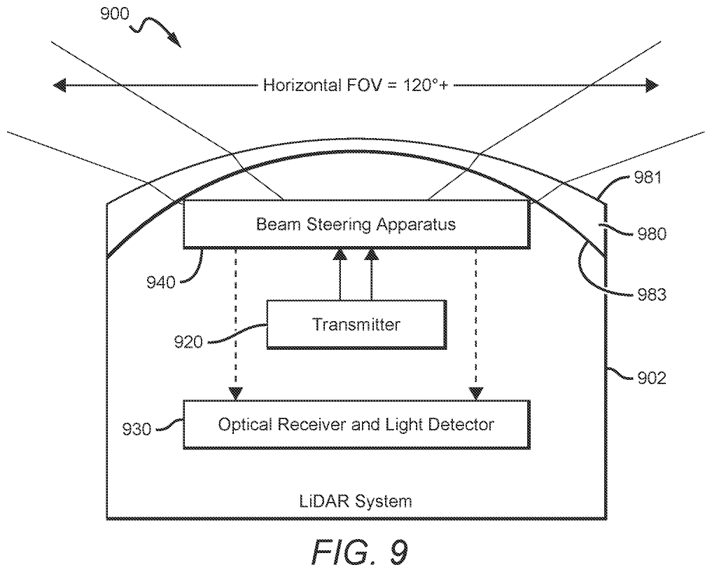

FIG. 9 is a block diagram illustrating an example curved window 980 for expanding the FOV of the LiDAR system 900, according to some embodiments. Similar to those in system 800, system 900 also has a housing 902, a transmitter 920, and an optical receiver and light detector 930. For simplicity, other components of LiDAR system 900 are omitted from FIG. 9. The housing 902 is coupled to a curved window 980 configured for expanding the FOV of the LiDAR system 900. In one embodiment, the curved window 980 comprises an outer surface 981 facing an outer side of the housing 902 of the LiDAR system and an inner surface 983 facing an inner side of the housing 902 of the LiDAR system. The thickness of the curved window 980 is represented by the distance between the outer surface 981 and the inner surface 983 at any particular location of the window 980. As illustrated in FIG. 9, the thicknesses near the left and right edges of the window 980 are greater than the thickness at the center portion of window 980. As a result, when passing through window 980, the transmission light beams scanned by beam steering apparatus 940 bend slightly by the window 980 because of the varying thickness of window 980. The bending of the transmission light beams helps to expand the beam scanning range horizontally to meet or exceed the HFOV requirement (e.g., 120 degrees or more). While FIG. 9 shows one cross section of window 980 from the left edge to right edge, it is understood that the cross-section of window 980 from the top edge to the bottom edge (i.e., a cross section that is perpendicular to the one shown in FIG. 9) can also be configured to have varying thickness. For instance, if the thicknesses of the window 980 near the top and bottom edges are greater than the center portion of window 980, the transmission light beams can also bend in the vertical direction to expand the beam scanning range vertically to meet or exceed the VFOV requirement (e.g., 30 degrees or more).

In some embodiments, as shown in FIG. 9, the thickness variation of the window 980 can be configured by making the curvature of the outer surface of the window 980 different from the curvature of the inner surface of window 980. The curvature of a surface at any specific point of the surface measures how the surface, at the specific point, deviates from being flat. There are two principal curvatures associated with a surface: the principal curvature in the direction of maximum curvature (denoted by k1) and the principal curvature in the direction of minimum curvature (denoted by k2). These curvatures are used to describe the shape and behavior of surfaces. If M denotes a surface and P denotes a point on the surface M. The maximum curvature k1 and minimum k2 are taken over a domain of kn. Curvatures k1 and k2 are called the principal curvatures of surface M at point P. The corresponding directions are called principal directions. The product K=K(P)=k1*k2 is the Gauss curvature of M at P. A radius of the curvature of a surface is the reciprocal of the curvature. Thus, the radius of the curvature at a point P is the radius of a circle which fits the curve or surface most snugly at the point P.

In FIG. 9, along one or more dimensions of window 980, the curvature of the outer surface 981 is smaller than the curvature of the inner surface 983 for at least some points on the surfaces. Thus, at least for some points on the inner and outer surfaces of window 980, the radius of inner surface 983 is smaller than the radius of outer surface 981. So at least for these points, the inner surface 983 bend more than the corresponding points of the outer surface 981. As a result, the thickness at any particular location of the window 980 varies from other locations.

With reference back to FIG. 7A, regular window 778 has a uniform thickness as described above. The uniform thickness also causes a beam quality problem. As shown in FIG. 7A, window 778 has substantially the same curvatures for its inner and outer surfaces, and therefore has equal thickness at any locations of window 778. As a result, the transmission light beams pass through the center portion of the window 778 have minimum distortion, but the light beams pass through the edge portion of the window 778 may have some beam distortion. The same distortion may also occur for the return light going into the LiDAR system 700. These kinds of beam distortion may reduce the beam quality and may thus be undesirable. For example, the beam distortion may cause the return light to have improper focus on the detector of the LiDAR system (e.g., the light spot on the detector may appear to be bigger compared to a properly focused light spot). The beam quality problem can be alleviated or eliminated by configuring, for example, the inner surface of the window while keeping the outer surface fixed.

With reference to FIG. 9 again, the shape and dimension (e.g., curvature) of outer surface 981 of window 980 may be fixed and cannot be easily adjusted. This is because a LiDAR system is often mounted to a vehicle, and therefore the outer surface of a LiDAR system may often be required to fit with the vehicle contour. As a result, the outer surface curvature may also be fixed and cannot be easily adjusted. To expand the FOV of the LiDAR system 900 and to reduce the beam distortion, the inner surface 983 of the LiDAR system 900 can be adjusted or configured in any desired manner. For example, the curvature of the inner surface 983 can be adjusted to obtain the desired thickness variations across the window 980. The beam quality difference between the edge and center portions of window 980 can also be mitigated or eliminated by properly configuring the shape, dimension, orientation, optical properties, and/or other parameters of the inner surface 983.

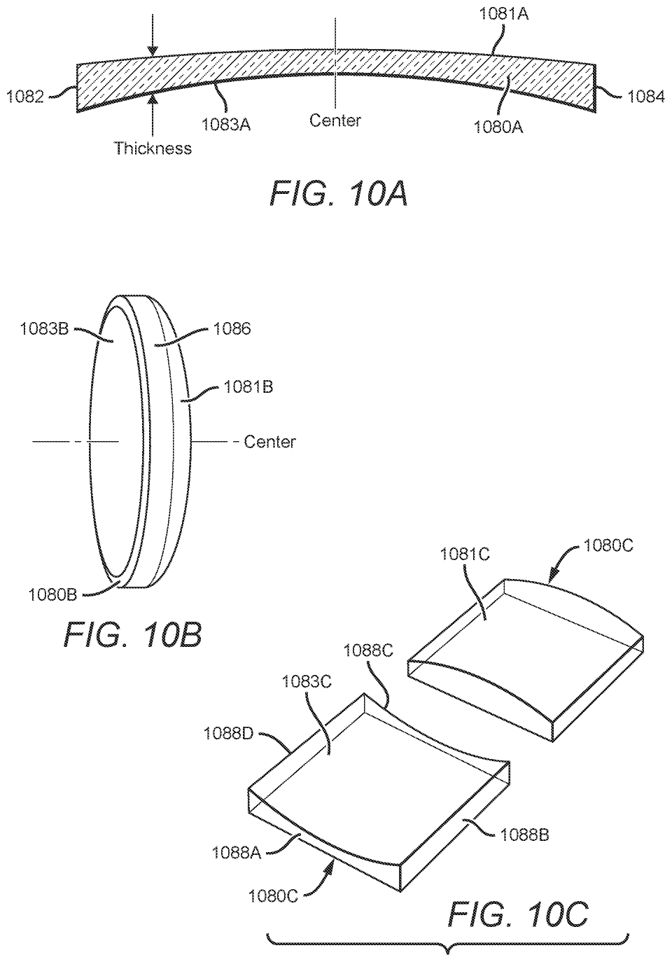

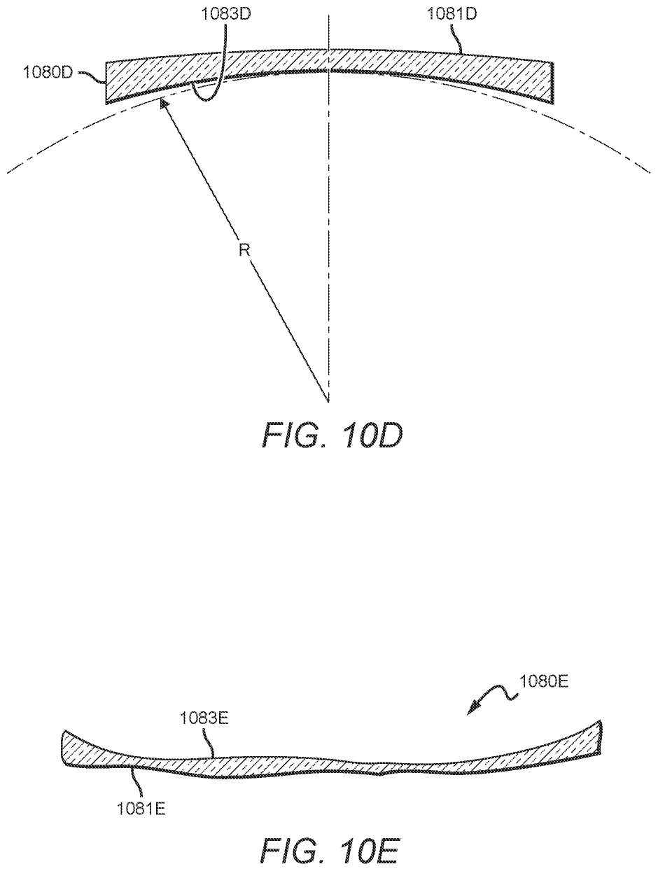

A curved window (e.g., windows 880 and 980) for expanding FOV of a LiDAR system can have many different shapes, including a meniscus lens shape, an aspheric lens shape, barrel shape, or a free-form lens shape, etc. FIGS. 10A-10F illustrate several of these shapes. The curved windows shown in FIGS. 10A-10F can be used to implement windows 880 and 980 in FIGS. 8 and 9. Starting with FIGS. 10A-10C, curved windows having a meniscus lens shape are illustrated with a cross-sectional view (FIG. 10A) and two perspective views (FIGS. 10B and 10C). With reference to FIGS. 10A-10C, curved windows 1080A-1080C all have a meniscus lens shape. Thus, the curvatures of the inner surfaces 1083A, 1083B, and 1083C are different from the curvatures of the respective outer surfaces 1081A, 1081B, and 1081C. For expanding the FOV of a LiDAR system, the inner surfaces have a greater curvature (or smaller radius) than the corresponding outer surfaces, such that the curve window appears to be bulging outward. This way, the light beams transmitted from the LiDAR system to an external environment bend outward to expand the FOV, as described above with respect to FIGS. 8 and 9. The return light coming into the LiDAR system from the external environment converges when they pass through the curved window.

In some embodiments, as shown in FIGS. 10A-10C, both the inner surface (e.g., 1083A, 1083B, or 1083C) and the outer surface (e.g., 1081A, 1081B, and 1081C) are curved with the inner surface having the greater curvature. In other embodiments, the outer surface may be a flat surface, depending on the vehicle contour fitting requirements, while the inner surface is a curved surface. In either configurations, the curved windows 1080A-1080C have asymmetrical design, with the outer surface having a larger radius (or smaller curvature) than the inner surface. In one embodiment, because of the asymmetrical design of a curved window, the thickness of the curved window decreases from a first edge to the center of the curved window, and the thickness of the curved window increases from the center of the curved window to a second edge of window. FIG. 10A shows that the first edge is the left edge 1082 and the second edge is the right edge 1084. If the curved window has a round-shape as shown in FIG. 10B, the first edge and the second edge can be any opposite sides of edge 1086. If the curved window has a square shape or a rectangle shape, as shown in FIG. 10C, the first edge and the second edge can be the left edge 1088B and right edge 1088D. In other words, the first edge and the second edge of a curved window define the left and right boundaries of the curved window (e.g., window 1080A or 1080C) in the horizontal direction.

In the embodiment shown in FIG. 10C, the thickness of the curved window 1080C also decreases from a third edge to the center of the curved window 1080C, and the thickness of the curved window 1080C increases from the center of the curved window to a fourth edge. The third edge and the fourth edge can be edge 1088A and 1088C, respectively. Thus, the third edge and the fourth edge of the curved window 1080C define the top and bottom boundaries of the curved window 1080C in the vertical dimension. While the edge definition and thickness variation are described using the meniscus-shaped curved windows shown in FIGS. 10A-10C, similar definitions and thickness variations can be also readily appreciated for other shaped curved windows (e.g., those in FIGS. 10D-10F).

With reference to FIG. 10B, in one embodiment, one or both of the inner surface 1083B and outer surface 1081B of curved window 1080B have a spherical shape. Thus, curved window 1080B can be similar to a spherical lens in optical properties. For example, inner surface 1083B and/or outer surface 1081B can have a curved, spherical surface (curvature of the surfaces can be different). The curvature for the inner surface, or the outer surface, is the same in all meridians across the surface, such that the curved window 1080B has the same optical power in all directions. Spherical-shaped curved window 1080B can thus be configured to converge light (e.g., when light returns to the LiDAR system from external of the window) and diverge light (e.g., when the light goes out of the window to the FOV).

With reference still to FIG. 10C, in one embodiment, one or both of the inner surface 1083C and outer surface 1081C of curved window 1080C have a cylindrical shape. The curved window 1080C thus can be similar to a cylindrical lens. For example, when one or both of the inner surface 1083C and outer surface 1081C of curved window 1080C have a cylindrical shape, curve window 1080C can have different optical power along one axis compared to the other. Unlike spherical-shaped window 1080B, cylindrical-shaped window 1080C is configured to manipulate the light in only one direction, also referred to as the axis of the cylinder. As described above, by configuring the left edge 1080B and right edge 1080D to be thicker than the center portion of curved window 1080C, the light going out of window 1080C can be slightly bend or diverged, thereby expanding the HFOV. If the thickness of the window 1080C in the vertical direction is uniform (e.g., similar to a cylindrical lens), then window 1080C does not change the VFOV. In addition, a cylindrical-shaped window can also reduce or eliminate optical aberrations such as astigmatism, which causes the return light to focus unevenly onto the detector of the LiDAR system.

FIG. 10D is a cross-sectional view of an example curved window 1080D having an aspherical lens shape, according to some embodiments. As shown in FIG. 10D, at least one of the inner surface 1083D and outer surface 1081D has an aspherical shape. The aspherical shaped window 1080D means that the curvature of the inner surface 1083D and/or outer surface 1081D is not uniform across the entire surface. Aspherical shaped window 1080D has surfaces that vary in curvature and shape. Aspherical shaped window 1080D can be configured such that the thickness at the edges is greater than the thickness at the center, thereby diverging the light going out of the window 1080D to expand the FOV. In addition, aspherical shaped window 1080D can also manipulate light to reduce or eliminate certain optical aberrations, including, e.g., spherical aberrations, coma, astigmatism, chromatic aberration, and distortion. By reducing and eliminating these aberrations, curved window 1080D can reduce image distortions, blurring, or other optical imperfections. As such, window 1080D can improve image quality across the entire field-of-view, and offer improved edge-to-edge sharpness. It is understood that at least some of these benefits and advantages can also be obtained with one or more of the other example curved windows described herein (e.g., window 880, 980, and 1080A-1080E).

FIG. 10E is a cross-sectional view of an example curved window 1080E having a freeform shape, according to some embodiments. The cross-section of window 1080E shown in FIG. 10E illustrates that one or both of inner surface 1083E and outer surface 1081E of window 1080E can have a freeform (i.e., the surface is not a spherical or cylindrical, or other traditional geometric shapes). Freeform window 1080E can have complex, non-rotationally symmetric surface profiles that are specifically configured to optimize the optical performance (e.g., to maximize the expansion of the FOV while also reducing or eliminating various optical aberrations including spherical aberrations, coma, astigmatism, and distortion).

In all the example curved window 1080A-1080E, at any particular position of the window, the curvature in one dimension (e.g., the vertical dimension) can be the same or different from another dimension (e.g., the horizontal dimension). Using window 1080C shown in FIG. 10C as an example, the horizontal dimension curvature (i.e., the curvature of the cylindrical surface) is greater than the curvature of the vertical dimension (i.e., there is no curvature or zero curvature in the vertical dimension because of the cylindrical shape).

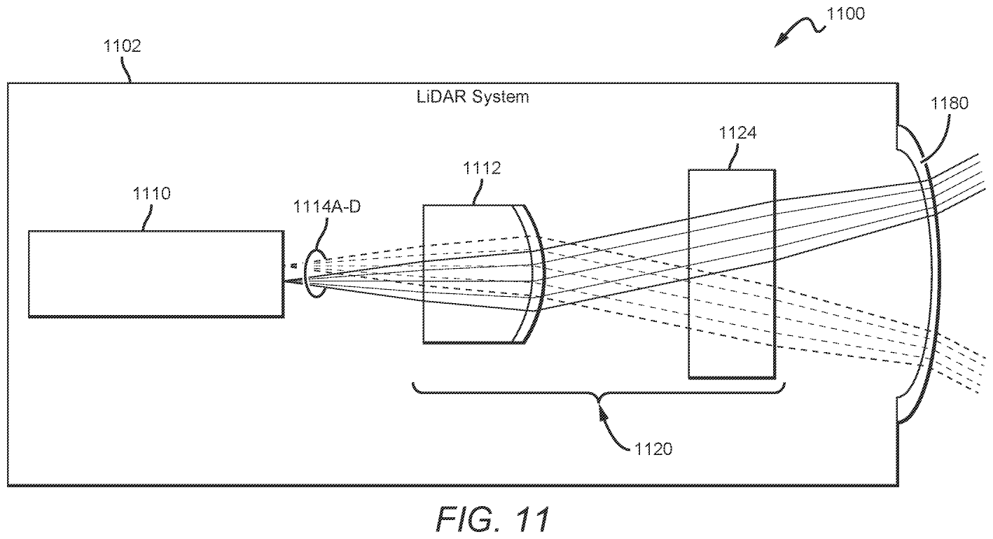

FIG. 11 is a block diagram of an example LiDAR system 1100 having pre-compensation optics used with a curved window for expanding the FOV of the LiDAR system, according to some embodiments. With reference to FIG. 11, similar to LiDAR system 800, LiDAR system 1100 includes a transmitter 1110 providing one or more transmission light beams (e.g., 1114A-1114D, collectively as 1114). For simplicity, only beams 1114A and 1114D are shown, while beams 1114B and 1114C are omitted. LiDAR system 1100 may also include one or more transmitter optics. On such transmitter optics is a collimation lens 1112. For any beam emitted by transmitter 1110, the light rays in the beam may diverge as they travel away from transmitter 1110. When a diverging beam of light enters collimation lens 1112, the lens 1112 refracts the light in such a way that the exiting light rays in the beam become parallel or nearly parallel. A beam having parallel light rays can travel further in distance, which can be helpful in LiDAR applications for detecting objects located far away. As shown in FIG. 11, different beams 1114A-1114D may have different angles when exiting collimation lens 1112. The angular spacing between the two adjacent beams is determined based on the pitch between the transmitters providing the two adjust beams (e.g., two fibers) and the focal length of collimation lens 1112. Within each beam, the light rays can be collimated by collimation lens 1112. It is understood that while the different beams appear to overlap with one another, they will become spatially separated if they travel sufficient distance away from the LiDAR system. Collimation lens 1112 usually has one or more curved surfaces, the curvatures of which are configured to achieve the desired level of collimation. Collimation lens 1112 can be plano-convex and/or plano-concave lens.

Similar to those described above, to expand the FOV of LiDAR system 1100, system 1100 can include a curved window 1180 integrated with, or mounted to, a housing 1102 of system 1100. Curved window 1180 can be substantially the same or similar to any of the curved windows described above (e.g., windows 880, 980, 1080A-1080E). Similar to those curved windows 880, 980, and 1080A-1080E described above, the curved window 1180 can be configured to expand the FOV of LiDAR system 1110 by slightly diverging the light beams scanned through window 1180. For simplicity, FIG. 11 omitted showing the steering mechanism. It is understood that a same or similar steering mechanism as mechanism 840 can be included in LiDAR system 1100 for scanning light beams to the FOV through window 1180. One problem with using the combination of collimation lens 1112 and curved window 1180 is that the collimated light beams formed by collimation lens 1112 can be distorted as they become diverged by curved window 1180, such that they are no longer parallel, or as parallel as when they come out of collimation lens 1112. In other words, the curved window 1180, while expanding the FOV, may also degrade the collimation quality of the transmission light beams. This may in turn affect the distance the light beams can travel to scan objects in the FOV.

In one example, to solve this problem, LiDAR system 1100 includes a pre-compensation optics 1124 disposed in the transmission light path. For example, the pre-compensation optics 1124 can be placed between the collimation lens 1112 and curved window 1180. It can also be placed in other places in the transmission light path, e.g., between transmitter 1110 and collimation lens 1112, between collimation lens 1112 and a steering mechanism (e.g., mechanism 840 shown in FIG. 8), between the steering mechanism and curved window 1180, etc.

Pre-compensation optics 1124 can be, for example, a converging lens or a focusing lens. They may have a large focal length. As such, pre-compensation optics 1124 can slightly converge the collimated light beams from collimation lens 1112. That is, when collimated light beams pass through pre-compensation optics 1124, they slightly refract (bend) inward to obtain pre-compensated transmission light beams. When the slightly converged light beams from pre-compensation optics 1124 pass through curved window 1180, the light beams are diverged slightly so that the light rays in any particular beam become collimated again. In this manner, the transmission light beams directed to curved window 1180 are pre-compensated (or pre-distorted) for correcting the distortion caused by window 1180, thereby solving the problem described above.

In some embodiments, pre-compensation optics 1124 can be a single lens or a lens group. Optics 1124 and collimation lens 1112 can form a lens group as a part of the transmitter optics for shaping and/or diverging the transmission light beams. Pre-compensation optics 1124 can also include one or more optics to pre-distort in one direction or in two directions. Optics 1124 adjusts at least one of the shape, direction, divergence, and focus of the transmission light beams 1114A-1114D.

In some examples, an alignment offset is introduced in the transmitting light path and/or the receiving light path to correct the distortion caused by a curved window 1180. For example, the curve window 1180 causes defocusing of the transmission light beams. This defocusing can be pre-compensated by adjusting the transmitter 1110's focal plane with respect to collimation lens 1112 (e.g., by moving the focal plane closer or further away from collimation lens 1112). In this example, no pre-compensation optics 1124 is needed for adjusting at least one of the shape, direction, divergence, and focus of the transmission light beams 1114A-1114D. In other examples, a combination of alignment offset and pre-compensation optics 1124 can be configured to correct the distortion caused by the curved window 1180. Similar alignment offset and/or compensation optics can be used in the receiving light path to correct the distortion of the return light caused by curved window 1180, as described below.

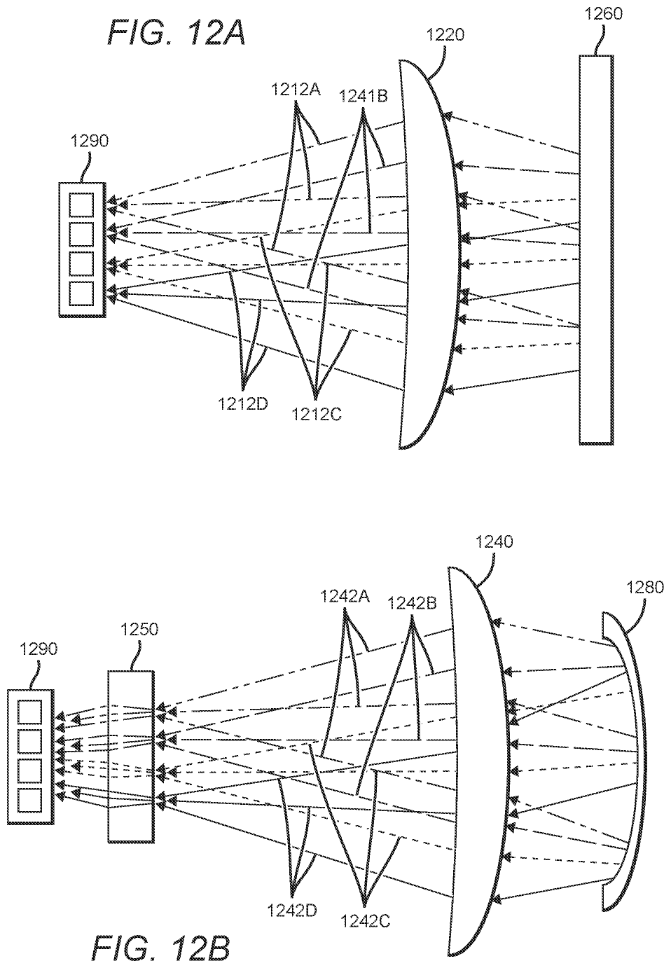

FIG. 12A is a diagram illustrating an example optical receiving light path for a LiDAR system having a flat aperture window that does not expand the FOV of the LiDAR system, according to some embodiments. As shown in FIG. 12A, in this receiving light path, return light is formed by scattering transmission light beams from objects in the FOV. The return light passes through the flat window 1260 (e.g., a window that does not have a curvature in either the outer surface or the inner surface). The return light is then directed by a steering mechanism to collection lens 1220. For simplicity, FIG. 12A does not show the steering mechanism but it can be the same or similar to steering mechanism 840 shown in FIG. 8. The collection lens 1220 can be a converging lens that focuses the return light to the detector 1290. FIG. 12A shows four different return light 1212A-1212D, corresponding to four transmission light beams (e.g., beams 1114A-1114D shown in FIG. 11). Because the transmission light beams have angular spacing between them, the return light 1212A-1212D also have corresponding angular spacing. Therefore, each of return light 1212A-1212D is focused by collection lens 1220 to a respective detector element in detector 1290.

FIG. 12B is a diagram illustrating an example optical receiving light path for a LiDAR system having a curved aperture window 1280 for expanding the FOV of the LiDAR system, according to some embodiments. In this receiving light path, return light is formed by scattering transmission light beams from objects in the FOV. The return light passes through the curved aperture window 1280, which can be similar to curved windows 880, 980, 1080A-1080E, or 1180 described above. Thus, curved window 1280 refracts (bends) the return light as they pass through its outer surface and inner surface. In some examples, curved window 1280 bends the return light so the return light slightly converges. This slight distortion of the return light may cause the downstream optics (e.g., the collection lens 1240) to improperly focus the return light onto the detector array 1290. Therefore, additional receiver optics may be needed to correct the distortion caused by curved window 1280.

As shown in FIG. 12B, the return light passes through the curved window 1280 (e.g., a window that has a curvature in either the outer surface or the inner surface, or both). The return light is then directed to collection lens 1240 via a steering mechanism. For simplicity, FIG. 12B does not show the steering mechanism but it can be the same or similar to steering mechanism 840 shown in FIG. 8. The collection lens 1240 can be a converging lens that direct the return light to the detector 1290. FIG. 12B shows four different return light 1242A-1242D, corresponding to four transmission light beams (e.g., beams 1114A-1114D shown in FIG. 11). Because the transmission light beams have angular spacing between them, the return light 1242A-1242D also have corresponding angular spacing. However, as described above, return light 1242A-1242D may each have some distortion caused by curved window 1280. The distortion can be corrected by using receiver optics 1250.

Receiver optics 1250 can be configured to compensate at least one of the shape and focus of the return light 1241A-1242D. For instance, receiver optics 1250 can be a lens that slightly diverges the return light. It may be a spherical lens, aspherical lens, a cylindrical lens, a freeform lens, or a lens group. Receiver optics 1250 is configured to receive the return light from collection lens 1240 and correct the distortion caused by curved window 1280. Receiver optics can then refocus each return light 1242A-1242D to their respective detector element of detector 1290. In this configuration of the receiving light path, the detector 1290 is not placed at the focal plane/point of collection lens 1240. Instead, receiver optics 1250 and collection lens 1240 can form a lens group, which is configured to have an effective focal plane/point at detector 1290. FIG. 12B shows that the receiver optics 1250 is placed between the detector 1290 and collection lens 1240. It is understood that receiver optics 1250 can be placed in other places in the receiving light path, e.g., between the curved window 1280 and the steering mechanism (not shown in FIG. 12B), between the steering mechanism and collection lens 1240, etc.). Optics 1250 adjusts at least one of the shape, direction, divergence, and focus of the return light 1242A-1242D.

As described above, an alignment offset is introduced in the transmitting light path and/or the receiving light path to correct the distortion caused by a curved window 1280. For example, the curve window 1280 causes defocusing of the return light 1242A-1242D. This defocusing can be compensated by adjusting the collection lens 1240's focal plane/point with respect to detector 1290 (e.g., by moving the focal plane closer or further away from detector 1290). In this example, no receiver optics 1250 is needed for adjusting at least one of the shape, direction, divergence, and focus of the return light 1242A-1242D. In other examples, a combination of alignment offset and receiver optics 1250 can be configured to correct the distortion caused by the curved window 1280.

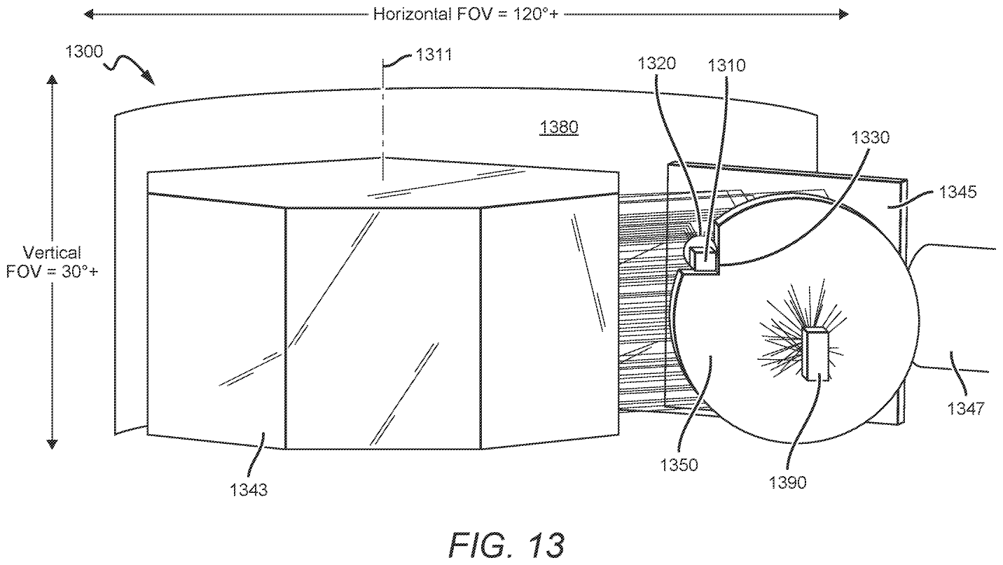

FIG. 13 is a diagram illustrating an example transceiver of a LiDAR system 1300 having a curved aperture window 1380 for expanding the FOV of the LiDAR system, according to some embodiments. One or more components of LiDAR system 1300 can be used to implement LiDAR systems 800, 900, and 1100 described above. In the embodiment shown in FIG. 13, LiDAR system 1300 includes an optical polygon mirror 1343, a transmitter 1310, transmitter optics 1320, collection lens 1350, an oscillation mirror 1345, a curved window 1380, and detector 1390.

FIG. 13 illustrates that optical polygon mirror 1343 and oscillation mirror 1345 can form a steering mechanism for scanning transmission light beams out of curved window 1380. Curve window 1380 can be the same or similar to windows 880, 980, 1080A-1080E, 1180, or 1280 described above. Therefore, the scanned transmission light beams can be refracted to expand the scanning FOV as described above. The scanning of the transmission light beams can be in both the horizontal direction and the vertical direction to the FOV. For instance, optical polygon mirror 1343 can scan light in the horizontal direction and oscillation mirror 1345 can scan light in the vertical direction. In one or both directions, curved window 1380 can be configured to bend the transmission light beams, by varying thicknesses, to expand the horizontal FOV and/or the vertical FOV. In the example shown in FIG. 13, optical polygon mirror 1343 comprises a plurality of reflective surfaces, also referred to as reflective facets. Each of the reflective surfaces has an orientation substantially parallel to a rotational axis 1311 of the optical polygon mirror 1343. Thus, the tilt angle of a reflective surface of polygon mirror 1343 is 90 degrees. That is, the normal direction of the reflective surface is perpendicular to rotational axis 1311.

FIG. 13 illustrates that LiDAR system 1300 includes a polygon mirror 1343 with a 90-degree tilt angle. Thus, the light directed by the polygon mirror 1343 can travel to or from other optical components in a substantially horizontal direction as shown in FIG. 13. As a result, the other optical components (e.g., oscillation mirror 1345) can be disposed on the side of polygon mirror 1343, thereby forming a lateral arrangement in LiDAR system 1300.

In other examples, one or more of the plurality of reflective surfaces may not be parallel to the rotational axis 1311 of the optical polygon mirror 1343. That is, the normal direction of the reflective surface is not perpendicular to the rotational axis 1311. Thus, in these example, the tilt angle of each reflective surface of the optical polygon mirror is not 90 degrees. The tilt angle may instead be an acute angle (e.g., if the reflective surface is tilted upward forming a tilt angle between 0-90 degrees) or an obtuse angle (e.g., if the reflective surface is tilted downward forming a tilt angle between 90-180 degrees). A polygon mirror having acute or obtuse tilt angles is also referred to as a wedged-shaped polygon mirror.

With reference still to FIG. 13, oscillation mirror 1345 can be, for example, a galvanometer mirror. Oscillation mirror 1345 can be operated by a motor 1347 positioned adjacent to oscillation mirror 1345 in a lateral manner as shown in FIG. 13. For example, the motor 1347 may be positioned laterally next to mirror 1345 such that it does not increase the height of the LiDAR system 1300. In other embodiments, LiDAR system 1300 may not include an oscillation mirror and may use just the optical polygon mirror 1343 to scan the FOV. Such an optical polygon mirror 1343 may be a variable angle multiple facet polygon (VAMFP) capable of performing scanning in both horizontal and vertical directions.

As described above, in some embodiments, LiDAR system 1300 is laterally arranged to reduce the vertical height. For instance, as shown in FIG. 13, the curved window 1380, optical polygon mirror 1343, and oscillation mirror 1345 are all arranged side-by-side laterally rather than being vertically stacked. In addition, the collection lens 1350 in the receiving light path is positioned laterally with respect to optical polygon mirror 1343 and oscillation mirror 1345. In one embodiment, collection lens 1350 has a notch or opening 1330 configured to accommodate transmitter 1310 and/or transmitting optics 1320. FIG. 13 illustrates that the notch or opening 1330 is located proximate to an edge or a corner (e.g., top left corner) of collection lens 1350. The notch or opening 1330 can also be located proximate to other positions (e.g., in the top middle part of the collection lens 1350, or external to collection lens 1350). The opening or notch 1330 has a dimension configured based on an optical receiving aperture requirement. If the dimension of opening or notch 1330 is too big, it may negatively affect the performance of the collection lens 1350. If it is too small, the transmitter 1310 (e.g., a fiber array) and/or transmitter optics 1320 (e.g., collimation lens and pre-compensation lens) may not be able to fit in. For instance, the size of the opening or notch 1330 can be selected such that collection lens 1350 has an optical receiving aperture sufficient to detect a 10% reflectivity target located at 200 meters or 250 meters distance, or at a longer distance. In some embodiment, the optical receiving aperture of the collection lens 1350 may be configured based on a receiving performance between 0.5 and 500 meters, inclusive. Thus, the dimensions of the collection lens 1350 and opening/notch 1330 can be selected based on the receiving aperture requirements. In some examples, collection lens 1350 is a low-profile collection lens that reduces the height of the LiDAR system 1300 while maintaining a sufficient optical receiving aperture (e.g., an aperture for detecting 10% reflectivity target at 200 m distance).

Through the notch or opening 1330, transmitter 1310 emits light beams toward oscillation mirror 1345 via transmitter optics 1320. Transmitter 1310 may include a multiple-channel transmitter (e.g., a transmitter fiber array or semiconductor based laser) that is at least partially disposed within the notch or opening 1330 to deliver light beams to transmitter optics 1320. The size and position of the notch or opening 1330 can be configured based on the receiving performance requirements or the detection range requirements (e.g., detection of 2 m to 200 m). Transmitter optics 1320 can include, for example, a collimation lens and a pre-compensation lens, which can be substantially the same or similar to collimation lens 1112 and pre-compensation optics 1124 described above in FIG. 11, respectively.

With continued reference to FIG. 13, as described above, oscillation mirror 1345 may oscillate to facilitate scanning of the transmission light beams in one direction (e.g., the vertical direction). In the configuration shown in FIG. 13, the light beams are redirected by the oscillation mirror 1345 to optical polygon mirror 1343, which is configured to scan the light beams in another direction (e.g., the horizontal direction). The optical polygon mirror 1343 further scans the light beams to an FOV through curved window 1380. It is understood that the transmission light beams from transmitter optics 1320 can also be directed first to polygon mirror 1343 and then to oscillation mirror 1345. Curved window 1380 can be sized to correspond to the optical aperture of LiDAR system 1300 such that transmission light beams are directed by the polygon mirror 1343 and/or oscillation mirror 1345 to cover the entire desired FOV. The FOV can, for example, have an HFOV of about 120 degrees or more, and an VFOV of about 30 degrees or more. The coverage of the expanded FOV is enabled by the curvatures of the inner and/or outer surfaces of curved window 1380, similar to those described above.

Similar to the curved windows 880 or 980 shown in FIGS. 8 and 9, in some embodiments, curved window 1380 (FIG. 13) forms a portion of an exterior surface of a housing (not shown in FIG. 13) of LiDAR system 1300. Light can pass through the curved window 1380. In some examples shown in FIG. 13, the left and right edges of window 1380 can be substantially parallel to the rotational axis 1311 of polygon mirror 1343 or other optics. In other examples, the left and right edges curved window 1380 can be tilted at an angle with respect to the rotational axis 1311, based on at least one of an orientation of the optical polygon mirror 1343 or an orientation of the transmitter and receiver optics. In one embodiment, curved window 1380 may include an antireflection coating.

As described above, polygon mirror 1343 scans light beams to an FOV to illuminate one or more objects in the FOV. The light beams are then scattered and/or reflected to form return light. The return light travels back through curved window 1380 and is received by optical polygon mirror 1343. The return light is then redirected by one or more reflective surfaces of optical polygon mirror 1343 to oscillation mirror 1345. In turn, oscillation mirror 1345 redirects the return light to collection lens 1350 via one or more receiver optics (between collection lens 1350 and oscillation mirror 1345, or between collection lens 1350 and detector 1390, not shown in FIG. 13). The receiver optics in LiDAR system 1300 can be the same or similar to receiver optics 1250. The receiver optics in system 1300 can thus also be used to correct the distortion caused by curved window 1380. Collection lens 1350 collects the return light and passes it to detector 1390, via the receiver optics for correcting the distortion. In some embodiments, the receiving optics may include one or more receiving fiber arrays (not shown) coupled to collection lens 1350 and detector 1390. The receiving fiber arrays can deliver the return light to detector 1390 and/or other receiving components (e.g., mirrors, prisms, fibers, ADC, APD, etc.) for detecting and processing the return light.

The optical detector 1390 can be configured to detect the return light and convert the return light to electrical signals. Detector 1390 can include multiple detector elements similar to the detector 1290 shown in FIG. 12.

In the above description, the combination of polygon mirror 1343 and oscillation mirror 1345, when moving with respect to each other, steers light both horizontally and vertically to illuminate one or more objects in the FOV of the LiDAR system 1300; and obtains return light formed based on the illumination of the one or more objects. This type of configuration thus uses the steering mechanism (e.g., comprising a polygon mirror and an oscillation mirror) for both steering light out to the FOV and directing return light to collection lens and receiving optics. This type of configuration is therefore referred to as the co-axial configuration, indicating that the transmitting light path and the receiving light path are co-axial or at least partially overlap. A co-axial configuration eliminates or reduces redundant optical components, thereby making the LiDAR system 1300 more compact and improving its efficiency and reliability.

In the lateral arrangement shown in FIG. 13, the overall height of LiDAR system 1300 depends on the maximum height of optical polygon mirror 1343, transmitting optics 1320, transmitter 1310, collection lens 1350, oscillation mirror 1345, the receiving optics (not shown), and the curved window 1380. For example, because these components are arranged laterally, the overall height of LiDAR system 1300 may be the same or substantially the same as the height of the optical polygon mirror 1343 or curved window 1380 (or whichever component has the maximum height). As a result, the overall height of the LiDAR system 1300 can be reduced or minimized.

In some examples, the curved window 1380 is an integral piece, surfaces of which have curvature configured to expand the FOV. The curved window 1380 further reduces the need of adding one or more lens or other optical components to expand the FOV, and reduces the need for changing the polygon mirror and the oscillation mirror design (which usually can be complex) and configuration (e.g., increase the polygon mirror rotational speed, which can be noisy). Thus, by combining the curved window 1380 with the lateral arrangement of the various optical components including the transmitter, polygon mirror, oscillation mirror, receiver optics, and collection lens, the overall physical profile of the LiDAR system is more compact, while not sacrificing the FOV coverage.

The foregoing specification is to be understood as being in every respect illustrative and exemplary, but not restrictive, and the scope of the invention disclosed herein is not to be determined from the specification, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A light detection and ranging (LiDAR) system, the system comprising:
a housing;
a transmitter configured to transmit one or more light beams;
a beam steering apparatus optically coupled to the transmitter to receive the one or more light beams, the beam steering apparatus comprising one or more moveable optics configured to scan the one or more light beams to a field-of-view and to receive return light; and
a curved window mounted to, or integrated with, the housing of the LiDAR system, wherein the curved window is shaped in a manner such that a thickness of the curved window varies along one or more dimensions of the curved window to facilitate bending at least some of the scanned one or more light beams to expand the field-of-view (FOV) in at least one of a horizontal direction or a vertical direction.

2. The system of claim 1, wherein the curved window has a meniscus lens shape, an aspheric lens shape, barrel shape, or a free-form lens shape.

3. The system of claim 1, wherein the thickness of the curved window decreases from a first edge to the center of the curved window, and wherein the thickness of the curved window increases from the center of the curved window to a second edge.

4. The system of claim 3, wherein the first edge and the second edge define the left and right boundaries of the curved window in the horizontal direction.

5. The system of claim 4, wherein both inner and outer surfaces of the curved window are of a cylindrical shape.

6. The system of claim 4, wherein at least one of inner and outer surfaces of the curved window are of an aspheric or freeform shape with varying local radius of curvature in the horizontal direction.

7. The system of claim 4, wherein the thickness of the curved window decreases from a third edge to the center of the curved window, and wherein the thickness of the curved window increases from the center of the curved window to a fourth edge.

8. The system of claim 7, wherein the third edge and the fourth edge of the curved window define the top and bottom boundaries of the curved window in the vertical direction.

9. The system of claim 7, wherein both inner and outer surfaces of the curved window are of a spherical shape.

10. The system of claim 7, wherein at least one of inner and outer surfaces of the curved window are of a barrel shape.

11. The system of claim 7, wherein the curvature of the curved window in the vertical direction is different from the curvature in the horizontal direction.

12. The system of claim 1, wherein the curved window comprises an outer surface facing an outer side of the housing of the LiDAR system and an inner surface facing an inner side of the housing of the LiDAR system, wherein the thickness of the curved window is represented by the distance between the outer surface and the inner surface.

13. The system of claim 12, wherein a curvature of the inner surface of the curved window is greater than a curvature of the outer surface of the curved window along the one or more dimensions of the curved window.

14. The system of claim 1, wherein the curved window is shaped accordance to a field-of-view (FOV) requirement such that the scanned one or more light beams are bent sufficiently to scan the FOV.

15. The system of claim 1, wherein the curved window comprises a single integrated optical piece.

16. The system of claim 1, further comprising one or more transmitter optics disposed between the transmitter and the curved window, the one or more transmitter optics being configured to pre-compensate at least one of the shape and divergence of the one or more light beams.

17. The system of claim 1, further comprising a receiver configured to receive return light, wherein at least one of:
the transmitter is configured to have an alignment offset to adjust at least one of the shape, direction, divergence, or focus of the one or more light beams; or
the receiver is configured to having an alignment offset to adjust at least one of the shape, direction, divergence, or focus of the return light

18. The system of claim 1, further comprising:
a receiver comprising a detector and one or more receiver optics, wherein the one or more receiver optics are disposed between the curved window and the detector, the one or more receiver optics being configured to compensate at least one of the shape and focus of the return light passed through the curved window.

19. The system of claim 18, wherein the one or more receiver optics comprise a cylindrical or a freeform lens.

20. A vehicle comprising a light ranging and detection (LiDAR) system, the system comprising:
a housing;
a transmitter configured to transmit one or more light beams;
a beam steering apparatus optically coupled to the transmitter to receive the one or more light beams, the beam steering apparatus comprising one or more moveable optics configured to scan the one or more light beams to a field-of-view and to receive return light; and
a curved window mounted to, or integrated with, the housing of the LiDAR system, wherein the curved window is shaped in a manner such that a thickness of the curved window varies along one or more dimensions of the curved window to facilitate bending at least some of the scanned one or more light beams to expand the field-of-view (FOV) in at least one of a horizontal direction or a vertical direction.
